(19) United States
(12) Patent Application Publication
(10) Pub. No.: US 2025/0099947 A1
(43) Pub. Date: Mar. 27, 2025

(54) METAL-CONTAINING PEPTOID MEMBRANES FOR HYDROLYSIS OF ORGANOPHOSPHATES

(71) Applicant: Battelle Memorial Institute, Richland, WA (US)

(72) Inventors: Chunlong Chen, Richland, WA (US); Thi Kim Hoang Trinh, Richland, WA (US); Biao Jin, Richland, WA (US); Ronald N. Zuckermann, Richland, WA (US)

(21) Appl. No.: 18/895,721

(22) Filed: Sep. 25, 2024

Related U.S. Application Data
(60) Provisional application No. 63/540,297, filed on Sep. 25, 2023.

(51) Int. Cl. B01J 27/24; B01J 31/12; B01J 35/59

(52) U.S. Cl. CPC B01J 27/24; B01J 31/12; B01J 35/59

(57) ABSTRACT

Membranes, articles, and methods for hydrolysis of compounds comprising ester or phosphate ester groups are disclosed. The membranes and articles comprise a plurality of peptoids, at least one peptoid of the plurality of peptoids has a hydrophobic unit, a hydrophilic unit, and a metal-coordination ligand. The metal-coordination ligands are configured to bind to one or more metal ions. The metal-containing peptoid membranes self-assemble and show high efficiency for catalytic organophosphate hydrolysis.

### REFERENCE TO RELATED APPLICATION

This application claims the benefit of U.S. Provisional Patent Application No. 63/540,297, filed on Sep. 25, 2023, the disclosure of which is incorporated herein by reference in its entirety.

### STATEMENT AS TO THE RIGHTS TO INVENTIONS MADE UNDER FEDERALLY SPONSORED RESEARCH OR DEVELOPMENT

This invention was made with Government support under Contract DE-AC0576RL01830 awarded by the U.S. Department of Energy. The Government has certain rights in the invention.

### TECHNICAL FIELD

The present disclosure generally relates to hybrid organic/inorganic materials having catalytic properties and methods for producing the materials, and more particularly to metal-containing peptoid membranes and articles embedded with same for hydrolysis of organophosphates and other compounds.

### BACKGROUND

Organophosphates are chemical compounds that are present in herbicides, pesticides, insecticides, nerve agents, and flame retardants. These compounds can leak into the environment and destroy the soil and human exposure to these chemicals can lead to severe health risks. Degradation of organophosphates to benign products requires cleavage of the phosphate ester bonds. The enzyme Pseudomonas diminuta phosphotriesterase (PTE) is known to provide hydrolytic efficiency towards organophosphates. The active site of PTE contains two zinc ions ligated by an aspartic acid (Asp-301), four histidines (His-55, His-57, His-201, and His-230), a carboxylated lysine (Lys-169), and a hydroxide ion. The PTE hydrolyzes the organophosphate by binding the phosphorus center to the active site metal ions, where the neighboring amino acids facilitate an intramolecular nucleophilic attack and cleave the phosphate ester bonds. Various biomimetic catalysts have been developed to mimic the active site of PTE, but these systems tend to be inefficient, costly, and difficult to deploy on a large scale. Thus, it would be beneficial to develop new systems degrading organophosphates into benign products.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Compositions, articles, and methods to hydrolyze organophosphates and other compounds having ester groups, or oxidize compounds having thiol, sulfide, or sulfhydryl groups are disclosed herein. In accordance with an aspect of the present disclosure, one such composition can be a membrane comprising a plurality of peptoids. At least one peptoid of the plurality of peptoids can include a hydrophobic unit, a hydrophilic unit, and a metal-coordination ligand.

An embodiment of the present disclosure can be a peptoid among the plurality of peptoids according to Formula I:

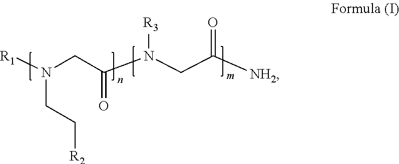

wherein R₁ can be the metal-coordination ligand; R₂ can be hydrogen, —OH, —COOH, —OCH₃, —NH₂, —SH, and —PO₃; R₃ can be hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl; n can be 1 to 10; m can be 1 to 10; and wherein any of the aforementioned can be substituted or unsubstituted.

In accordance with another embodiment of the present disclosure, a peptoid can have a formula according to Formula II:

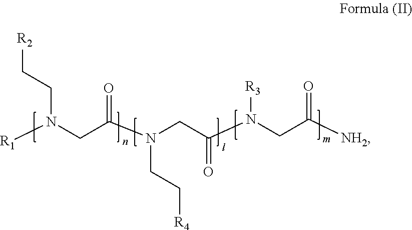

wherein R₁ can be the metal-coordination ligand; R₂ and R₄ are each independently selected from hydrogen, —OH, —COOH, —OCH₃, —NH₂, —SH, and —PO₃; R₃ can be hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl; 1 can be 0 to 10; n can be 1 to 10; m can be 1 to 10; and wherein any of the aforementioned can be substituted or unsubstituted.

Consistent with an aspect is a membrane having a peptoid of Formula I or Formula II for degrading organophosphates. The membrane can include a plurality of peptoids having one or more metal-coordination ligands configured to bind with one or more metal ions. The metal ions can be a transition metal selected from titanium, vanadium, chromium, manganese, iron, cobalt, nickel, copper, zinc, lanthanum, europium, zirconium, silver, gold, or combinations thereof.

In accordance with another aspect is a method for degrading a pesticide. The method can include combining a peptoid membrane with one or more metal ions, crystallizing the peptoid membrane, and exposing the peptoid membrane to a pesticide such that at least a portion of the pesticide is hydrolyzed. The peptoid among the plurality of peptoids can include a composition of formula (I) or (II). The method can further include embedding a solid substrate with the peptoid membrane and one or more metal ions. The solid substrate can include a piece of clothing, fabric, string, matrix, collagen, leather, paper, polymer, plastic, glass, wood, metal surface, cement, soil, rock, or solid aggregate of minerals or mineraloids.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

FIG. 1A is a schematic of an example peptoid having a hydrophobic unit, a hydrophilic unit, and a metal-coordination ligand.

FIG. 1B is a perspective view of an example membrane having a plurality of peptoids and metal ions.

FIG. 1C is a schematic of an example mechanism of hydrolysis of an organophosphate, in accordance with an embodiment of the present disclosure.

FIG. 1D is a schematic of an example peptoid membranes having varying lengths of hydrophilic units, in accordance with an embodiment of the present disclosure.

FIGS. 1E and 1F are schematics of example peptoid membranes having varying side chains on the hydrophilic unit, in accordance with an embodiment of the present disclosure.

FIG. 2A is a series of AFM topographic images of example metal-containing peptoid membranes with various metal-coordination ligands.

FIG. 2B is a plot of X-ray diffraction (XRD) spectra of example metal-containing peptoid membranes with various metal-coordination ligands.

FIG. 3A is a plot of hydrolysis conversion rate versus time of a control and example peptoid membranes with metal ions.

FIG. 3B is a bar graph comparing catalytic activity (k_{cat}/k_{uncat}) of example peptoid membranes with metal ions.

FIG. 3C is a bar graph comparing catalytic activity (k_{cat}/k_{uncat}) of example peptoid membrane, Pep-5 in a variety of morphologies, including an amorphous peptoid and metal ion mixture, an amorphous peptoid-metal ion complex, a peptoid membrane with unbound metal ions, and a crystalline peptoid-metal membrane.

FIG. 4A is a bar graph comparing catalytic activity (k_{cat}/k_{uncat}) of example metal-containing peptoid membranes with different hydrophilic lengths.

FIG. 4B is a series of AFM topographic images of example metal-containing peptoid membranes with different hydrophilic lengths.

FIG. 4C is a series of TEM images of example metal-containing peptoid membranes with different hydrophilic lengths.

FIG. 4D is a plot of XRD spectra of example metal-containing peptoid membranes with different hydrophilic lengths.

FIG. 5A is a series of AFM topographic images of example metal-containing peptoid membranes with different hydrophilic groups.

FIG. 5B is a plot of XRD spectra of example metal-containing peptoid membranes with different hydrophilic groups.

FIG. 5C is a bar graph comparing catalytic activity (k_{cat}/k_{uncat}) of example metal-containing peptoid membranes with different hydrophilic groups.

FIG. 5D is a bar graph comparing catalytic activity (k_{cat}/k_{uncat}) of example Pep-11-Co²⁺ peptoid membrane in a variety of conditions of varying pH and temperature.

FIG. 6A is a series of AFM topographic images of example peptoid membranes with a varying active site density and after the 3^{rd} catalytic cycle.

FIG. 6B is a plot of XRD spectra of example peptoid membranes assembled from Pep-5:Pep-1 at a ratio of 1:2, and the Pep-5-Co²⁺ membrane after the 3^{rd} cycle hydrolysis.

FIG. 6C is a bar graph comparing catalytic activity (k_{cat}/k_{uncat}) of example peptoid membranes with a varying density of metal-ligand active sites including peptoid-Co²⁺ membranes assembled from Pep-5 and Pep-1 with a molar of 0:1, 1:2, 1:1, and 2:1 and 1:0.

FIG. 6D is a bar graph comparing catalytic efficiency (%) of example peptoid membrane, Pep-5-Co²⁺ membrane, after cycles of hydrolysis.

FIG. 7 is a series of TEM images of example peptoid membranes with metal ions.

FIG. 8A is a UV-vis spectrum of absorbance versus wavelength for titration of example peptoid membrane, Pep-1, with metal ions.

FIG. 8B-I is a plot of absorbance at specific wavelengths versus equivalence of metal ion concentration for titration of example peptoid membrane, Pep-2, with metal ions.

FIG. 8B-II is a UV-vis spectrum of absorbance versus wavelength of the titration of FIG. 8B-I.

FIG. 8C-I is a plot of absorbance at specific wavelengths versus equivalence of metal ion concentration for titration of example peptoid membrane, Pep-3, with metal ions.

FIG. 8C-II is a UV-vis spectrum of absorbance versus wavelength of the titration of FIG. 8C-I.

FIG. 8D-I is a plot of absorbance at specific wavelengths versus equivalence of metal ion concentration for titration of example peptoid membrane, Pep-4, with metal ions.

FIG. 8D-II is a UV-vis spectrum of absorbance versus wavelength of the titration of FIG. 8D-I.

FIG. 8E-I is a plot of absorbance at specific wavelengths versus equivalence of metal ion concentration for titration of example peptoid membrane, Pep-5, with metal ions.

FIG. 8E-II is a UV-vis spectrum of absorbance versus wavelength of the titration of FIG. 8E-I.

FIG. 8F-I is a plot of absorbance at specific wavelengths versus equivalence of metal ion concentration for titration of example peptoid membrane, Pep-6, with metal ions.

FIG. 8F-II is a UV-vis spectrum of absorbance versus wavelength of the titration of FIG. 8F-I.

FIGS. 9A-9F are UV-vis spectra of absorbance at 616 nm versus wavelength and plots of A₆₁6/A₅₃₅ versus metal ion concentration for titration of example peptoid membranes with varying metal ions.

FIG. 10 is a bar graph comparing percentage of metal ion binding for various example peptoid membranes.

FIG. 11 is an FT-IR spectra of example peptoid membrane, Pep-5 with metal ions.

FIGS. 12A-12D are a series of AFM topographic images of an example peptoid membrane under various conditions including heat at 60° C. for 2 hours (FIG. 12A), heat at 90° C. for 2 hours (FIG. 12B), in ethanol for 2 hours (FIG. 12C), and in 20 mM NEM at pH 10 for one week (FIG. 12D).

FIG. 13A is a change in UV-vis spectra over time of an example peptoid membrane during hydrolysis of compounds containing phosphate ester groups.

FIG. 13B is a calibration curve of 4-nitrophenolate in 20 mM NEM at pH 10.

FIG. 13C is a plot of concentration of compounds containing phosphate ester groups versus time illustrating the effect of metal ions on the hydrolytic activity of example peptoid membranes with metal ions.

FIGS. 14A and 14B provide plots of absorbance at 315 nm versus equivalence of metal ion concentration for an example peptoid membrane, Pep-5, illustrating kinetic of increase in absorbance upon adding amounts of different metal cations.

FIG. 14C is a bar graph comparing quantitative amount of metal ion binding to example peptoid membrane, Pep-5.

FIGS. 15A-15C provide fluorescent microscopy images of example peptoid membranes with metal ions.

FIG. 16 is a series of TEM images of example peptoid membranes with metal ions.

FIG. 17A is a TEM image of an example metal-containing peptoid membrane, Pep-5, after 3 cycles of hydrolysis.

FIG. 17B is an FT-IR spectrum of metal-containing peptoid membrane of FIG. 17A after 3 cycles of hydrolysis.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the compositions, membranes and processes described herein are contemplated with or without explicit description of the particular combination. Additionally, unless explicitly recited otherwise, any aspect and/or feature disclosed herein can be combined to describe inventive features consistent with the present disclosure.

In this disclosure, while compositions, membranes, and processes are often described in terms of “comprising” various components or steps, the compositions, membranes, and processes also can “consist essentially of” or “consist of” the various components or steps, unless stated otherwise.

The terms “a,” “an,” and “the” are intended to include plural alternatives, e.g., at least one. For instance, the disclosure of “a metal ion” or “a substrate” is meant to encompass one, or combinations of more than one, metal ion or substrate, unless otherwise specified.

Various numerical ranges are disclosed herein. When a range of any type is disclosed or claimed, the intent is to disclose or claim individually each possible number that such a range could reasonably encompass, including end points of the range as well as any sub-ranges and combinations of sub-ranges encompassed therein, unless otherwise specified. As a representative example, the present disclosure recites that the density of metal ions present on a surface of the membrane can be in certain ranges. By a disclosure that a membrane comprises about 60% to about 90% of metal ions, the intent is to recite that the density of metal ions can be any percentage in the range and can include any range or combination of ranges from 60% to 90% (e.g., from about 65% to about 82%, or from about 88% to about 89%, and so forth). Likewise, all other ranges disclosed herein should be interpreted in a manner similar to this example.

Although any methods, devices, and materials similar or equivalent to those described herein can be used in the practice or testing, the typical methods, devices, and materials are herein described. It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

All publications and patents mentioned herein are incorporated herein by reference in their entirety for the purpose of describing and disclosing, for example, the constructs and methodologies that are described in the publications and patents, which might be used in connection with the present disclosure.

### DETAILED DESCRIPTION

Disclosed herein are metal-containing peptoid membranes for catalytic cleaving of organophosphates and other compounds. Articles coated with or otherwise attached to such membranes are also disclosed herein. The peptoid composition and architectural structure of the membranes lends itself to highly efficient catalytic hydrolysis and/or oxidation with precise control of density and position of the active sites for such catalytic activities. To adjust the environment of the active site, the peptoid compositions can be adjusted in a variety of ways, as described herein. These adjustments allow for highly versatile catalytic membranes for hydrolysis and/or oxidation of compounds.

In general, peptoids are a class of biomimetic sequence-defined polymers. In peptoids, the side chain is connected to the nitrogen of what otherwise is structurally the same as a peptide backbone, instead of the α-carbon as in peptides. Notably, peptoids lack the amide hydrogen, which is responsible for many of the secondary structure elements in peptides and proteins. The structure of a peptoid is close to that of a peptide except that the side chains are appended to the amide nitrogen rather than the α carbon. As such, peptoids can self-assemble into 2D nanosheets or 1D nanotubes, nanofibers, 3D spherical vesicles and other architectures.

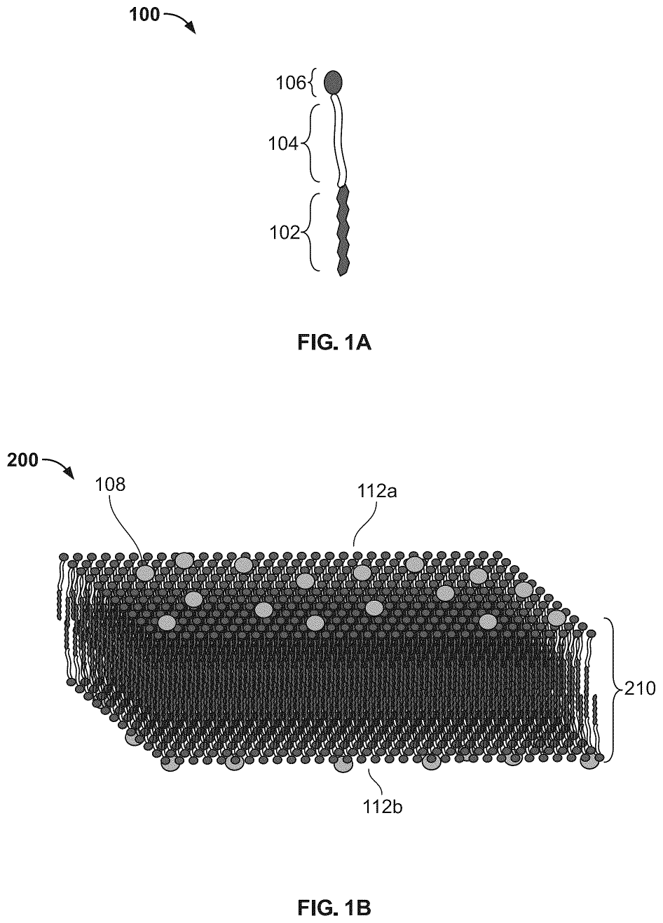

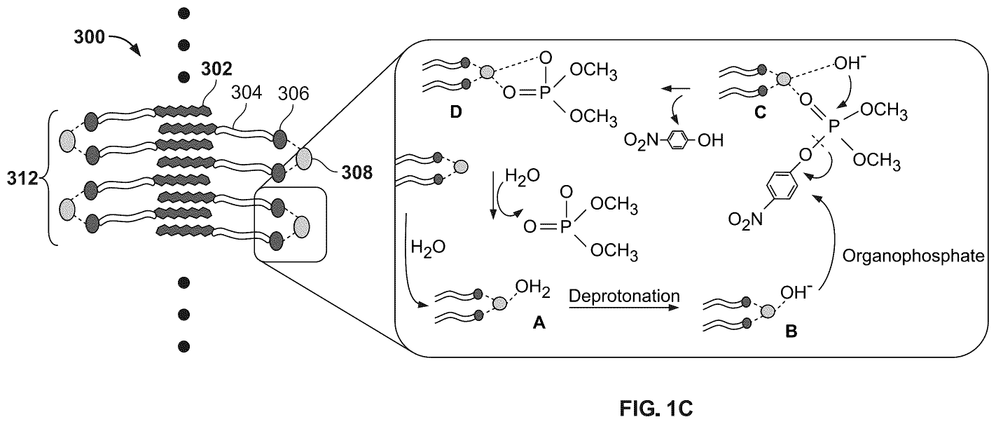

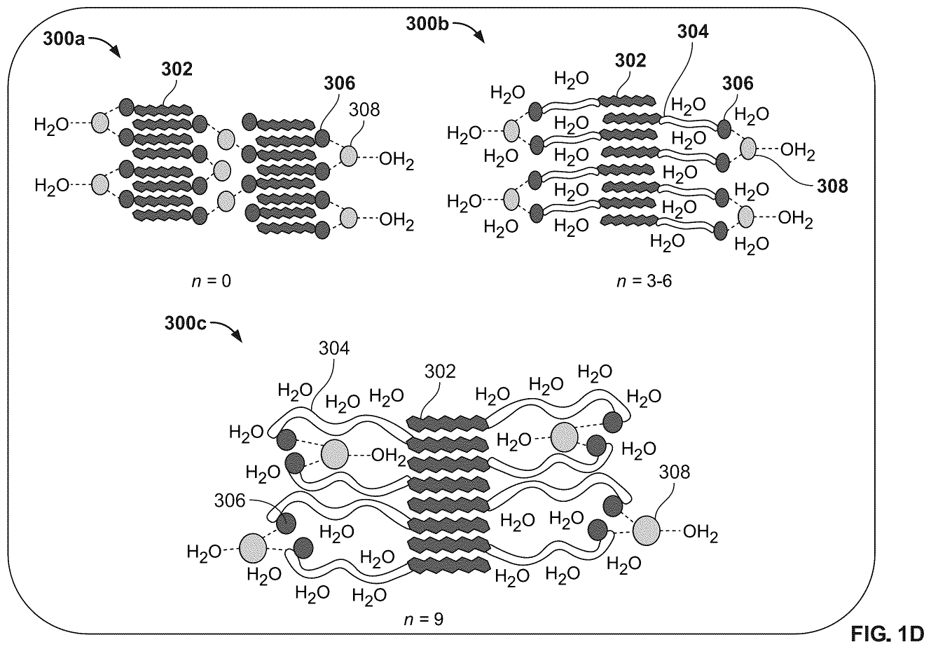

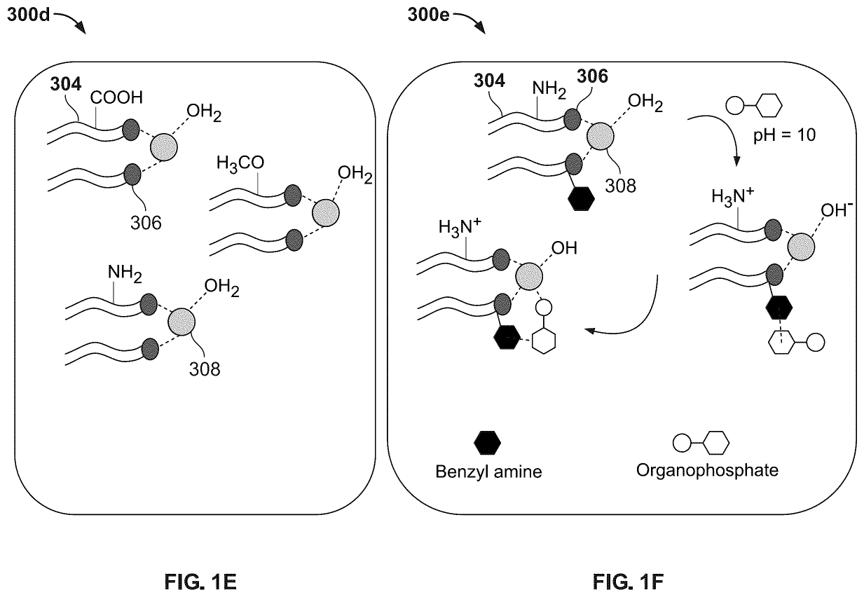

FIG. 1A is an example schematic illustrating peptoid 100 with hydrophobic unit 102, hydrophilic unit 104, and metal-coordination ligand 106. As shown in FIG. 1B, one or more peptoids 100 can self-assemble into structured nanomembranes or nanotubes. For instance, FIG. 1B illustrates a 2D membrane 200. Peptoids 100 can be synthesized with a specific sequence that can tune the surface chemistry of membrane surface 212a, 212b, such as charge or neutrality, hydrophobicity or hydrophilicity, covalent attachment of specific functional groups, molecular probes, and/or attraction or repulsion towards certain target compounds, and combinations thereof. These characteristics can be useful for achieving high photostability, detection sensitivity, and enhanced catalytic performance.

In some embodiments, peptoid 100 can be represented by the structure:

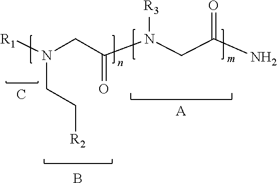

Component A, hydrophobic unit 102:

In some embodiments, hydrophobic unit 102 can include a functional group at R₃ of the structure above that includes linear or branched hydrocarbon chains functionalized with substituted or unsubstituted alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, heteroaryl, or combinations thereof. Such hydrophobic units can be substituted with one or more halogen or nitro groups. Hydrophobic unit 102 can include one or more of the following functional groups off the R₃ of the structure above:

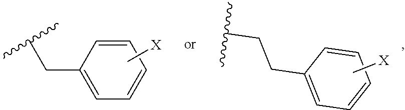

where X is a halogen. For instance, hydrophobic unit 102 can include

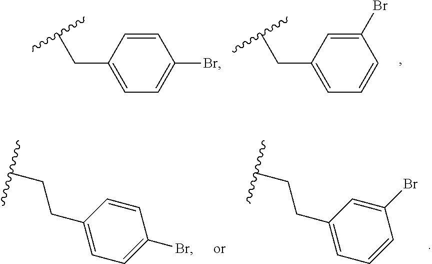 [SMILES: *Cc1ccc(Br)cc1 ; *Cc1cccc(Br)c1 ; "," ; *CCc1ccc(Br)cc1 ; *CCc1cccc(Br)c1 ; "."]

The length of hydrophobic unit 102, m, can vary from 0 to 10. As would be appreciated by one of skill in the art, increasing the length of the hydrophobic unit will increase the thickness of membrane 200 and may generate alternative architectures in the 2D and 3D structure.

### Component B, Hydrophilic Unit 104:

In some embodiments, hydrophilic unit 104 can include one or more functional groups at R₂ of the above structure that can independently be substituted or unsubstituted amino groups, hydroxyl groups, aldehyde groups, carboxyl groups, ether groups, methoxy groups, thiol groups, phosphate groups, or combinations thereof.

The length of hydrophilic unit 104, n, can vary from 0 to 10. As the hydrophilic unit is near the surface 212a, 212b of membrane 210, the length of hydrophilic unit 104 can impact the surface chemistry and the active site of hydrolysis. As such, the length, n, and composition of hydrophilic unit 104 is an important factor to consider for each application, as described in more detail herein.

In some embodiments, hydrophilic unit 104 can include two or more functional groups, B1 and B2, according to the following structure:

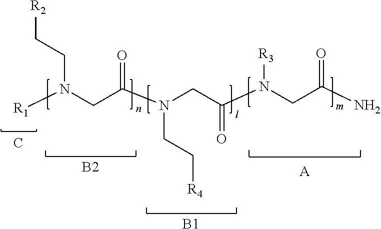

For peptoids having two or more functional groups B1 and B2, the length of hydrophilic unit 104, n and l can independently vary from 1 to 10. As described above, the length of hydrophilic unit 104 can impact the surface chemistry and the active site of hydrolysis. As such, the length of each n and l of hydrophilic unit 104 is an important factor to consider for each application.

### Component C, Metal-Coordination Ligand 106:

In some embodiments, metal-coordination ligand 108 can include one or more functional groups at R₁ of the above structure that can independently be any of the following:

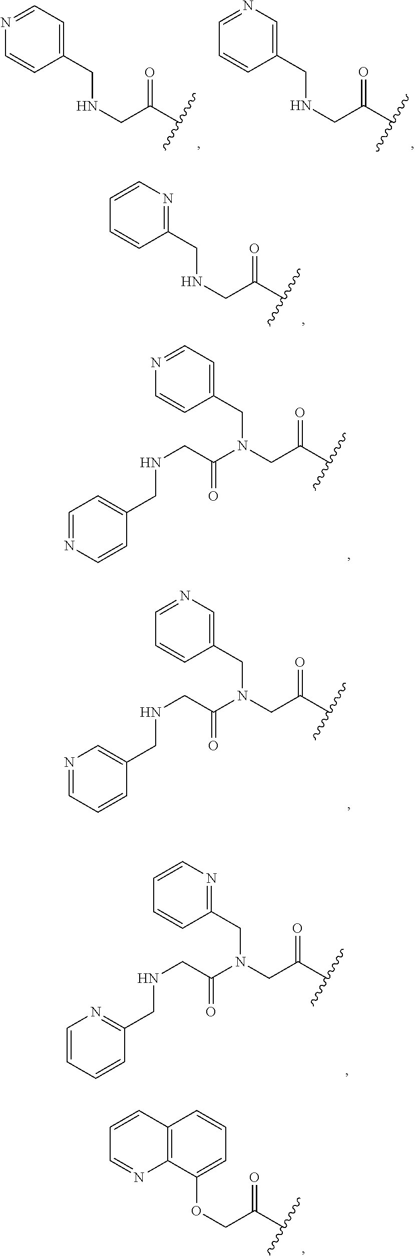

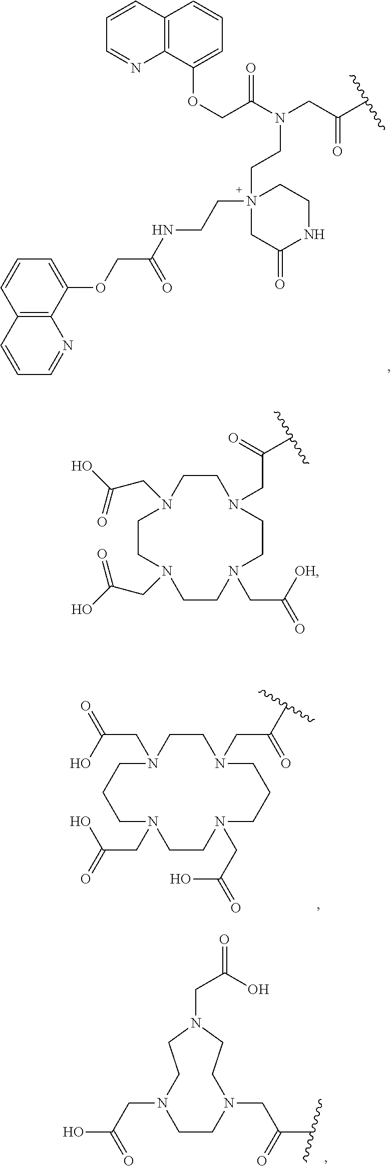

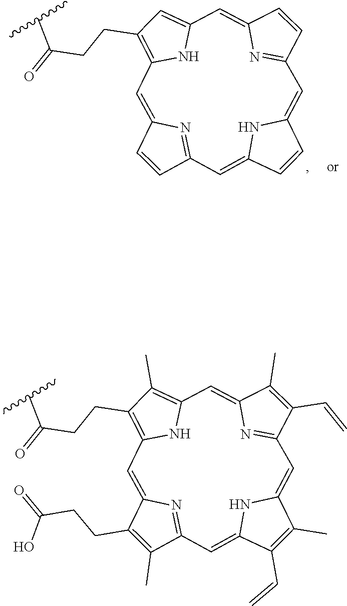 [SMILES: *C(=O)CCc1cc2cc3nc(cc4ccc(cc5nc(cc1[nH]2)C=C5)[nH]4)C=C3 ; *C(=O)CCc1c(C)c2cc3nc(cc4[nH]c(cc5nc(cc1[nH]2)C(CCC(=O)O)=C5C)c(C=C)c4C)C(C=C)=C3C]

In some embodiments, metal-coordination ligand 106 can be at least one of pyridyl, 8-hydroxyguinoline, N-(2-amino-2-oxoethyl)-N-(pyridin-4-ylmethyl)-2-((pyridin-4-ylmethyl)amino)acetamide (“Npy₂”), 1-(2-(N-(2-amino-2-oxoethyl)-2-(quinolin-8-yloxy)acetamido)ethyl)-3-oxo-1-(2-(2-(quinolin-8-yloxy)acetamido)ethyl)piperazin-1-ium (“Nqn₂”), N-(2-methoxyethyl)glycine (“Nome”), N-(2-aminoethyl)glycine) (“Nae”), N-(1-phenylmethyl)glycine (“Npm”), N-(isopropyl)glycine (“Nip”), 1,4,7,10-tetraazacyclododecane-N,N,N,N-tetraacetic acid (“DOTA”), 1,4,7-triazacyclononane-N,N,N-triacetic acid (“NOTA”), 1,4,8,11-tetraazacyclotetradecane-1,4,8,11-tetraacetic acid (“TETA”), diethylenetriaminepentaacetic acid (“DTPA”), iminodiacetic acid (“IDA”), 4,11-bis(carboxymethyl)-1,4,8,11-tetraazabicyclo[6.6.2]hexadecane (“CB-TE2A”), 1,8-Diamino-3,6,10,13,16,19-hexaazabicyclo[6,6,6]-eicosane (“DiAmSar”), and 3,3′,3″-(((1,4,7-triazonane-1,4,7-triyl)tris(methylene))tris(hydroxyphosphoryl))tripropanoic acid (“TRAP”), or combinations thereof.

In any of the embodiments disclosed herein, the hydrolysis activity of membrane 200 can be adjusted by changing the sequence and structure of peptoid 100 such as by altering the length of either the hydrophobic unit 102 or hydrophilic unit 104. Alternatively, or in addition thereto, one or more peptoids 100 can be tuned by changing side chains that adjust the hydrophobicity of the hydrophobic unit 102 or hydrophilic unit 104.

Turning to FIG. 1B, membrane 200 can form a membrane 210 of peptoids 100. On at least one surface 212a, 212b of membrane 210, one or more metal ions 108 can bind with one or more peptoids 100. The metal ions 108 can specifically bind with one or more metal-coordination ligands 106 to form a coordination bond. As described herein, metal ions are essential for catalytic action of many enzymes, both naturally occurring and synthetic. In particular metal ions contribute to the catalytic process through their ability to attract or donate electrons, bind the target substrate at the active site, or contribute to maintaining the tertiary and quaternary structures of the enzyme. For instance, in phosphate ester hydrolysis, metal ions contribute to binding between the active site and the phosphorus center of a compound having a phosphate ester. The binding facilitates the intramolecular nucleophilic attack that can lead to the cleavage of such phosphate ester bonds.

In some embodiments, membrane 200 can form membrane 210 with a single layer. The metal ions 108 can be positioned on one or more surfaces 212a, 212b of membrane 210. In some embodiments, as shown in FIG. 1B, membrane 210 is a bilayer sheet with hydrophilic units 104 of the peptoids 100 positioned near a surface 212a, 212b of membrane 210 and hydrophobic units 102 positioned internally. Peptoids 100 with both a hydrophobic unit 102 and hydrophilic unit 104 can self-assemble into bilayers similar to lipid bilayers that form the membrane of organelles in cells. The bilayer can have a thickness of a few nanometers (e.g., ranging from about 0.01 nm to about 1 nm, from about 0.1 nm to about 2 nm, from about 1 nm to about 5 nm, from about 2 nm to about 8 nm, from about 3 nm to about 12 nm, from about 4 nm to about 15 nm, from about 5 nm to about 20 nm, from about 10 nm to about 30 nm, and any value in between).

Membrane 200 can also form multiple bilayers (e.g., multilayer stacked membranes). In such an arrangement, the surface area can increase to increase the density of metal ions that bind to exposed surfaces of multilayer stacked membrane. In some embodiments, membrane 200 can self-assemble into membranes of varying architectures, such as, for example, nanotubes and dendritic structures. In other embodiments, membrane 210 can form micelles or liposomes for applications such as vesicles for drug delivery.

In some embodiments, metal ions 108 that bind to metal-coordination ligand 106 can be one or a combination of transition metals such as, for example, titanium, vanadium, chromium, manganese, iron, cobalt, nickel, copper, zinc, lanthanum, europium, zirconium, silver, or gold.

The density of metal ions 108 that bind to the surface of membrane 200 can impact the catalytic activity of membrane 200. In some embodiments, membrane 200 can have a ratio of peptoid to metal ion ranging from about 0.01:2 to about 2:0.01 (e.g., from about 0.1:2, from about 0.2:2, from about 0.5:2, from about 0.75:2, from about 1:2, from about 2:1.75: from about 2:1.5, from about 2:1.2, from about 2:1, from about 2:0.75, from about 2:0.5, from about 2:0.2, from about 2:0.1, from about 1:1.75: from about 1:1.5, from about 1:1.2, from about 1:1, from about 1:0.75, from about 1:0.5, from about 1:0.2, from about 1:0.1, and any range in between).

One issue with biomimetic catalysts is their difficulty in preparation and the denaturing or inactivation upon exposure to environmental or catalytic conditions. Advantageously, and unexpectedly, the metal-containing peptoid membranes of the present disclosure also exhibit remarkable properties, such as high chemical stability, selective reactivity, and the ability to self-repair.

Potential applications for the metal-containing peptoid membranes and related materials include hydrolysis of compounds having phosphate ester groups, such as, for example, organophosphate pesticides (e.g., parathion, chlorpyrifos, diazinon, dichlorvos, phosmet, fenitrothion, tetrachlorvinphos, azamethiphos, azinphos-methyl, malathion, methyl parathion, quinalphos, sulfotep), insecticides (e.g., acephate, azinphos-methyl, chlorethoxyfos, coumaphos, diazinon, dichlorvos, dicrotophos, dimethoate, disulfoton, ethion, ethoprop, ethyl parathion, fenamiphos, fenitrothion, fonofos, isoxathion, malathion, methamidophos, methidathion, mevinphos, naled, phosmet, profenofos, propetamphos, tebupirimfos, temephos, terbufos, tetrachlorvinphos, triazofos), herbicides (e.g., tribufos, merphos, bensulide), industrial plasticizers (e.g., tricresyl phosphate, 2-ethylhexyl diphenyl phosphate), nerve gases (e.g., soman, sarin, tabun, VX), ophthalmic agents (e.g., Echothiophate, isoflurophate), antihelmintics (e.g., trichlorfan), flame retardants (e.g., bisphenol A diphenyl phosphate, triphenyl phosphate, tricresyl phosphate, tributyl phosphate, TDCPP, TCPP and TCEP). For hydrolysis of organophosphates, the metal-containing peptoid membranes may be embedded, coated over, or immobilized on a substrate. The substrate may be exposed to the organophosphate compound, where the compound is attracted to the one or more metal ions at the active site and undergoes a hydrolysis reaction such that the compound is hydrolyzed.

The substrate can include clothing, fabric, string, matrix, collagen, leather, paper, polymer, plastic, glass, wood, metal surface, cement, soil, rock, or solid aggregate of minerals or mineraloids. For some applications, metal-containing peptoid membranes can be incorporated on filters to hydrolyze organophosphate compounds in air, vapor, or other fluids. As a nonlimiting example, incorporation of metal-containing peptoid membranes on respirator cartridges can be used by farmers in agricultural applications or by soldiers on the battlefield.

In any of the embodiments described herein, metal-containing peptoid membranes can be incorporated on substrates by any conventional deposition technique. For instance, spin coating and plasma-enhanced chemical vapor deposition (PECVD) and the like.

Exemplary non-limiting examples of peptoids for metal-containing peptoid membranes include the following:

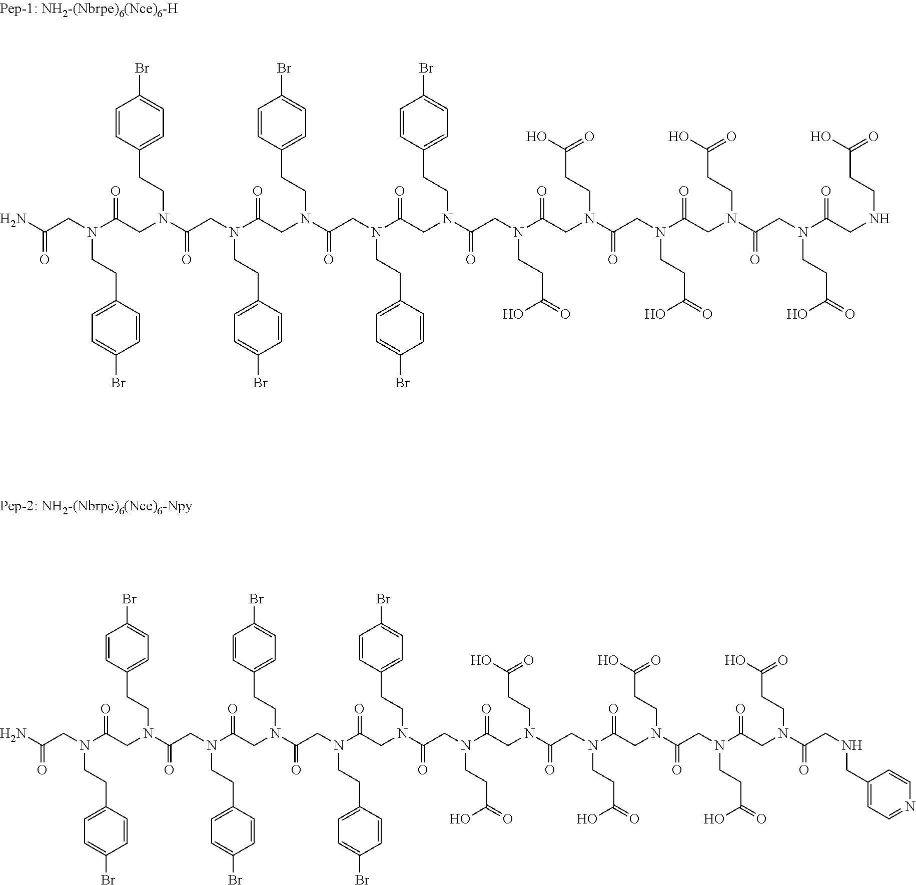 [SMILES: NC(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCC(=O)O)C(=O)CN(CCC(=O)O)C(=O)CN(CCC(=O)O)C(=O)CN(CCC(=O)O)C(=O)CN(CCC(=O)O)C(=O)CNCCC(=O)O ; NC(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCc1ccc(Br)cc1)C(=O)CN(CCC(=O)O)C(=O)CN(CCC(=O)O)C(=O)CN(CCC(=O)O)C(=O)CN(CCC(=O)O)C(=O)CN(CCC(=O)O)C(=O)CN(CCC(=O)O)C(=O)CNCc1ccncc1]

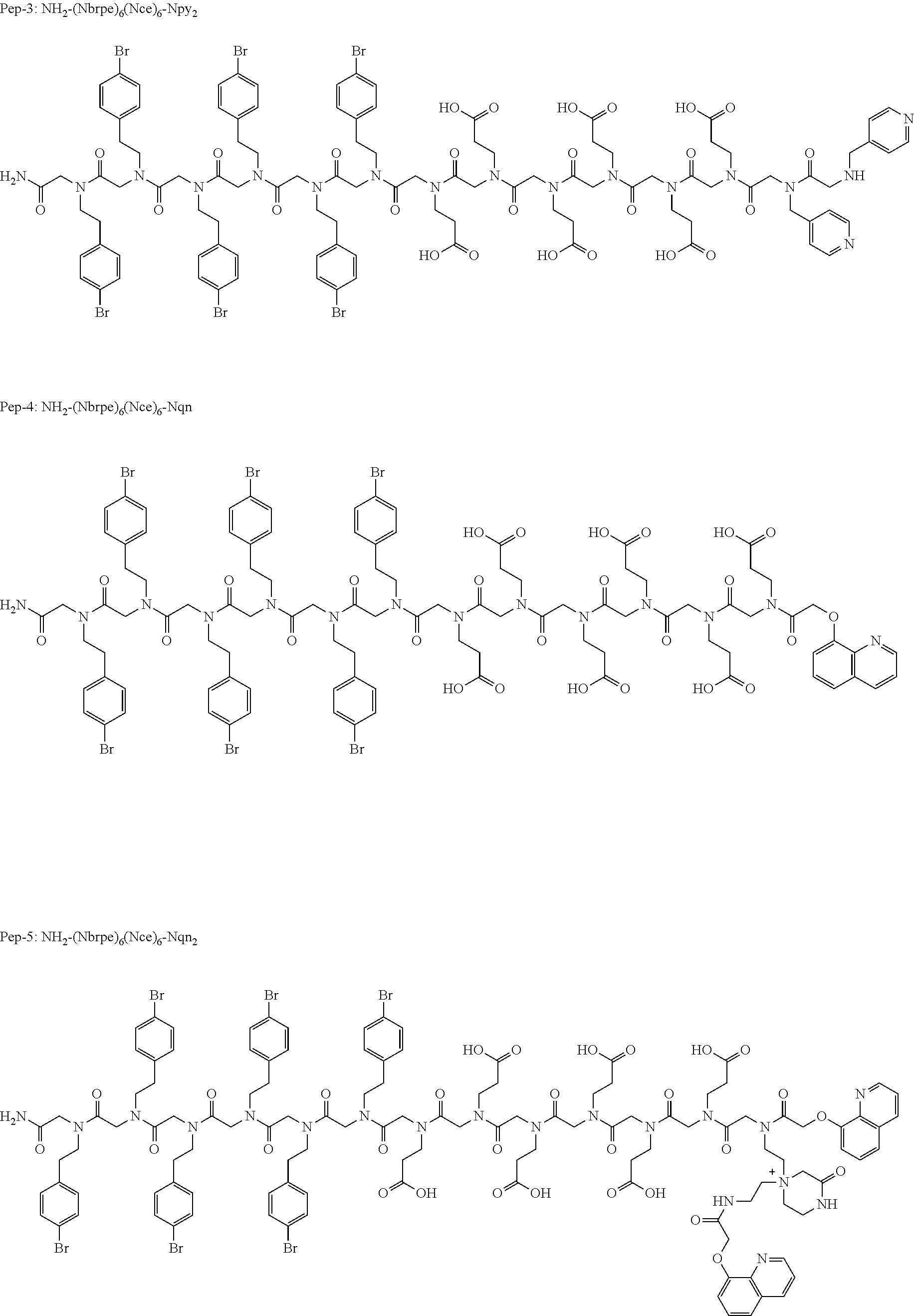

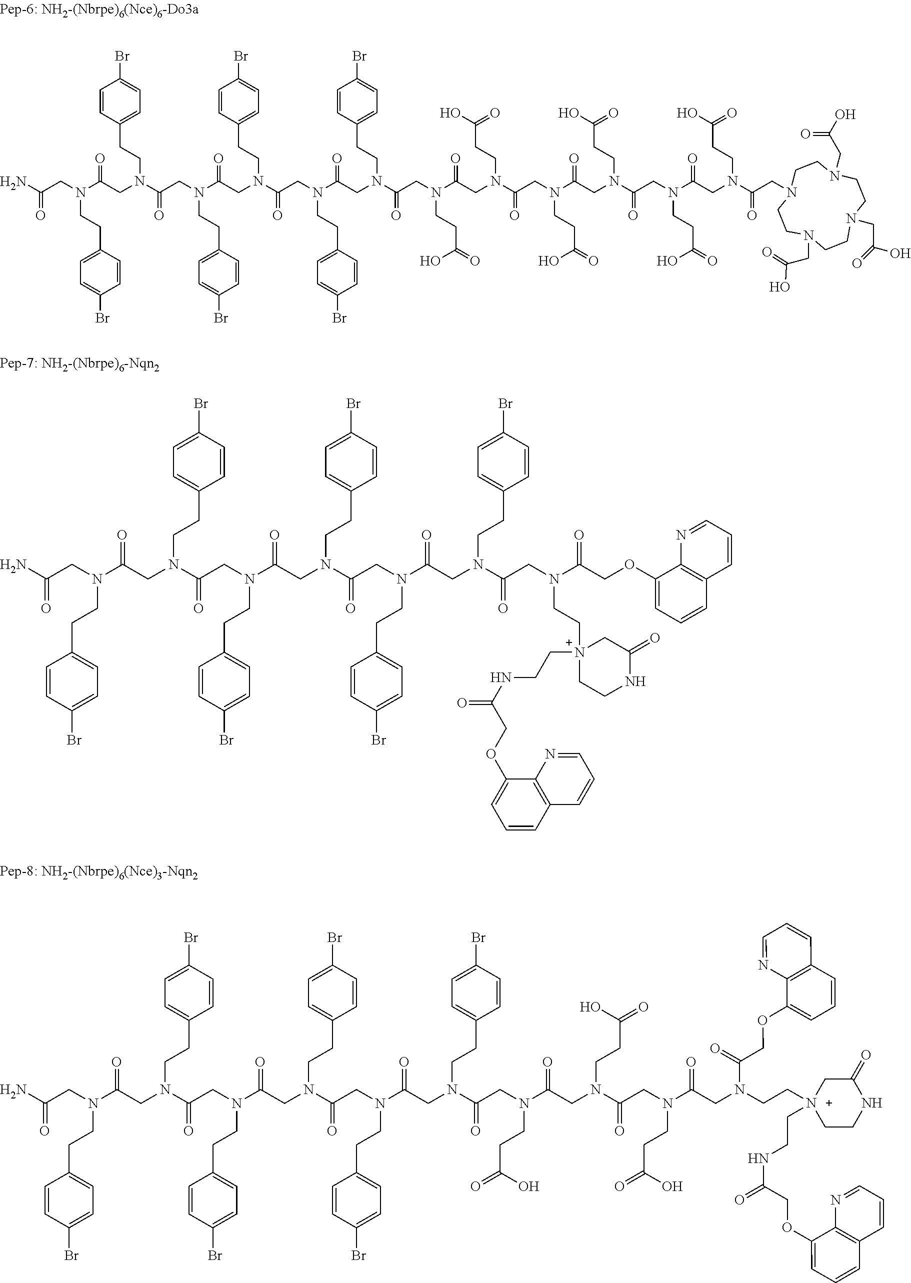

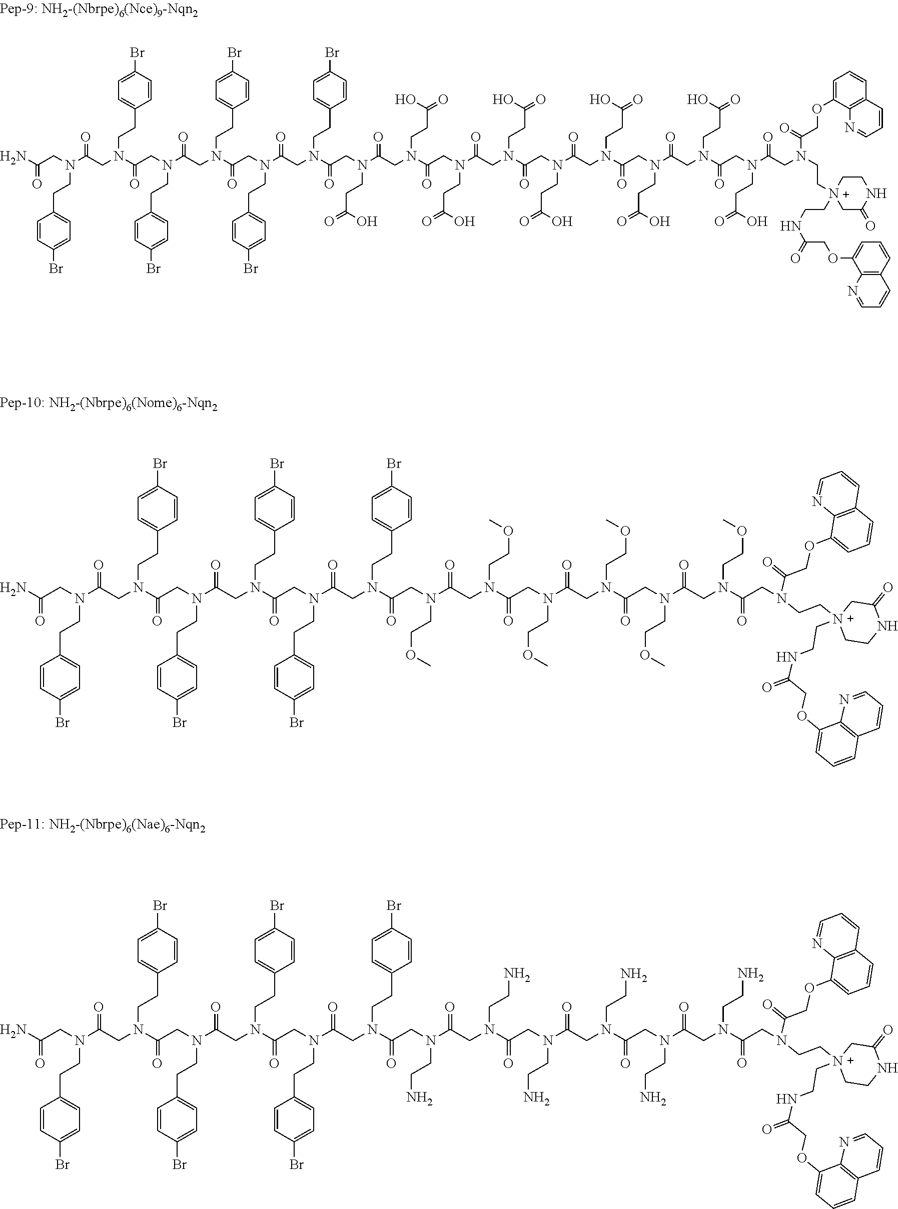

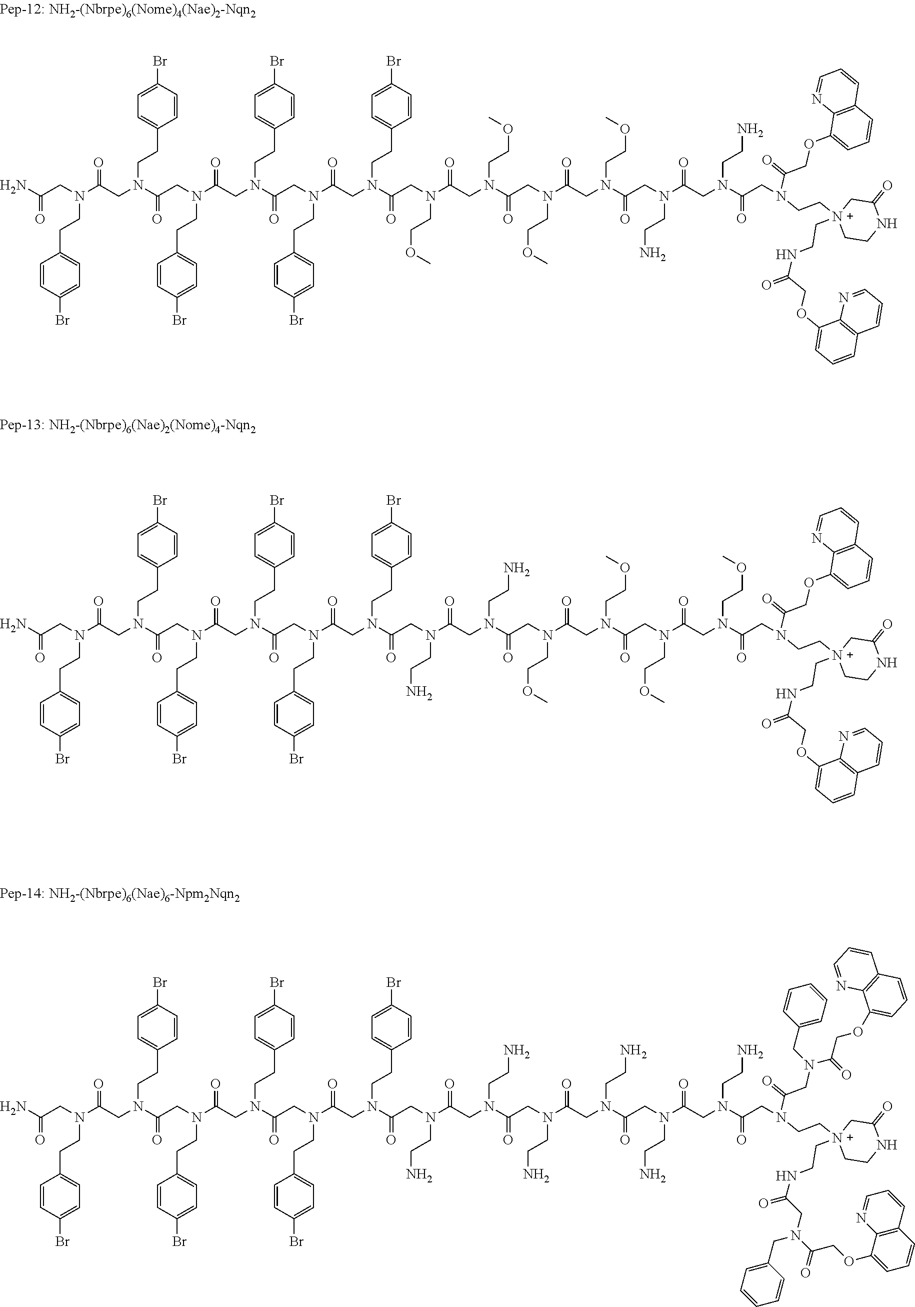

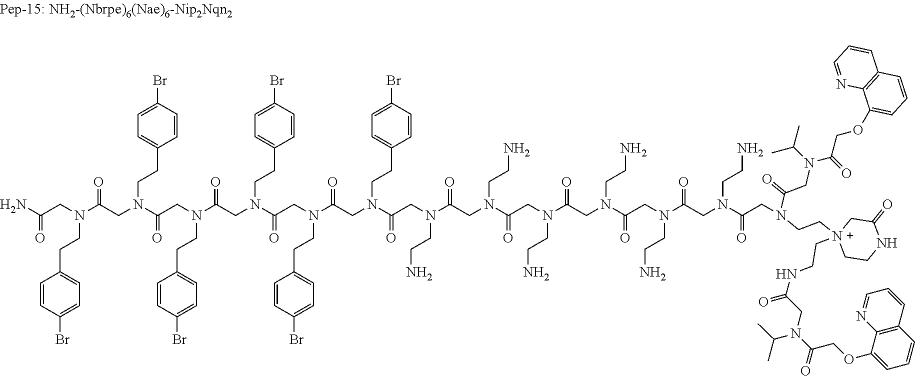 [SMILES: CC(C)N(CC(=O)NCC[N+]1(CCN(CC(=O)N(CCN)CC(=O)N(CCN)CC(=O)N(CCN)CC(=O)N(CCN)CC(=O)N(CCN)CC(=O)N(CCN)CC(=O)N(CCc2ccc(Br)cc2)CC(=O)N(CCc2ccc(Br)cc2)CC(=O)N(CCc2ccc(Br)cc2)CC(=O)N(CCc2ccc(Br)cc2)CC(=O)N(CCc2ccc(Br)cc2)CC(=O)N(CCc2ccc(Br)cc2)CC(N)=O)C(=O)CN(C(=O)COc2cccc3cccnc23)C(C)C)CCNC(=O)C1)C(=O)COc1cccc2cccnc12]

Turning to FIG. 1C, a schematic of an example mechanisms for hydrolysis of organophosphates with metal-containing peptoid membrane 300 is provided. As shown, metal-containing peptoid membrane 300 is made of hydrophobic units 302, hydrophilic units 304, metal-coordination ligands 306, and metal ions 308. The metal-containing peptoid membrane 300 self-assembles into a robust and crystalline nanomembrane that exposes Lewis acid metal ions 308 of at least one surface 312, replicating the active site of PTE and mimicking the natural PTE-like microenvironment. To initiate the hydrolysis process, water molecules bound to the metal ion undergo deprotonation from step “A” to “B”, allowing for substrate binding. This is followed by a nucleophilic attack at step “C”, resulting in the cleavage of the P—O bond from step “C” to “D”. Subsequently, the attachment of a water molecule to the metal center can regenerate the active site for the next catalytic cycle from step “D” to “A”.

FIGS. 1D-1F are schematics of metal-containing peptoid membranes 300a, 300b, 300c with modified chemical structures to adjust the microenvironment of the peptoid membrane. Such changes in the peptoids enable the metal-containing peptoid membranes to be finely tuned for the specific catalytic activity required.

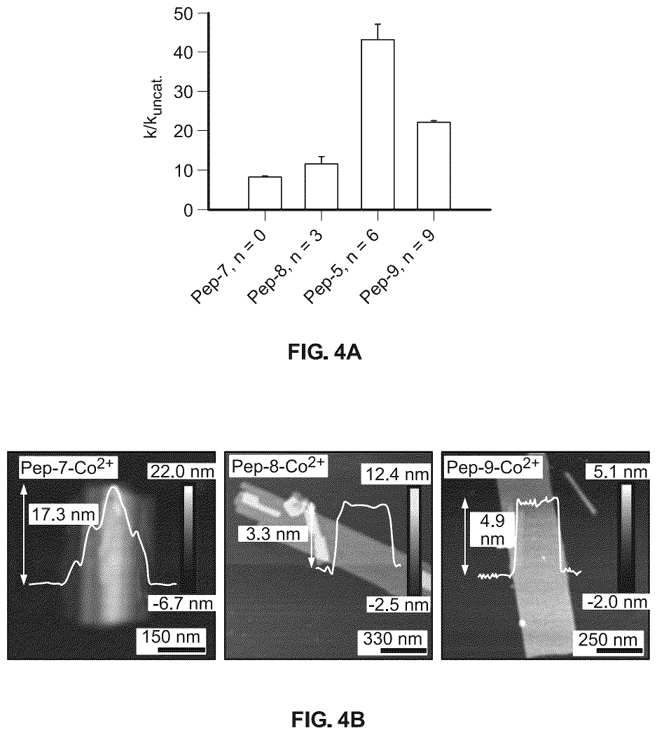

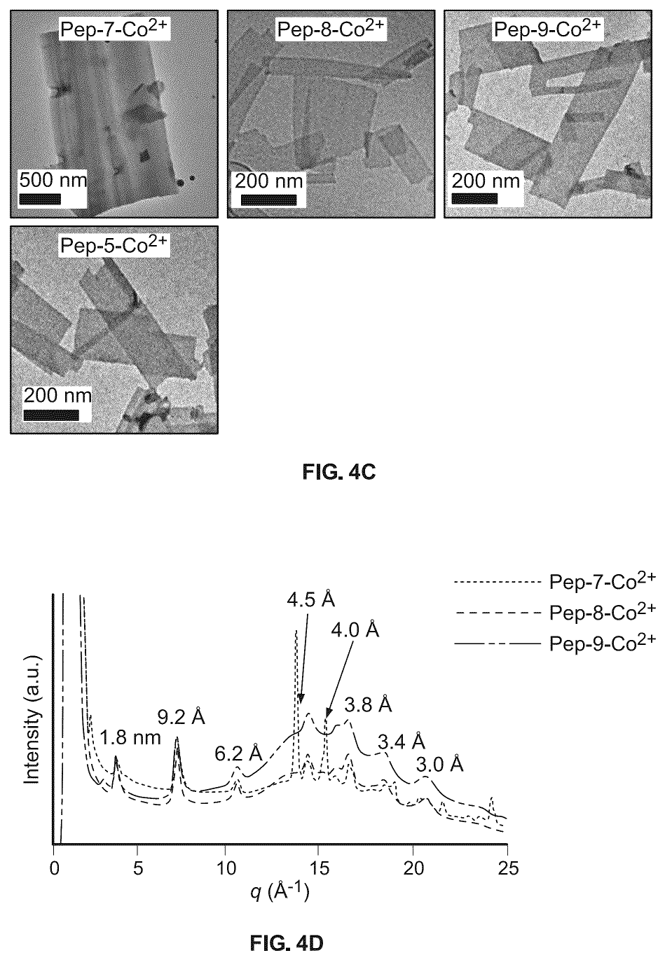

As shown in FIG. 1D, the microenvironment of metal-containing peptoid membranes 300 (of FIG. 1C) have been modified by adjusting the length of the hydrophilic units 304 from n=0 (300a), 3-6 (300b), and 9 (300c). For instance, by increasing the number of —COOH groups in the hydrophilic unit 304, the hydrolytic performance can significantly enhance. This enhancement is demonstrated in comparing the catalytic performance of Pep-5, Pep-7, Pep-8, and Pep-9 and is shown in FIG. 4A. During hydrolysis, the presence of water and the hydrophilic domain is crucial, as it creates a water network around the metal center and supplies an external nucleophile for the regeneration of the metal active site. However, when the hydrophilic domain becomes too long (n=9), it can lead to an excessive level of hydrophilicity and flexibility. That could reduce the effectiveness of certain organophosphates or hydrophobic substrates to bind effectively to the active site. Therefore, achieving an optimal length of the hydrophilic domain helps enhance the hydrolytic activity.

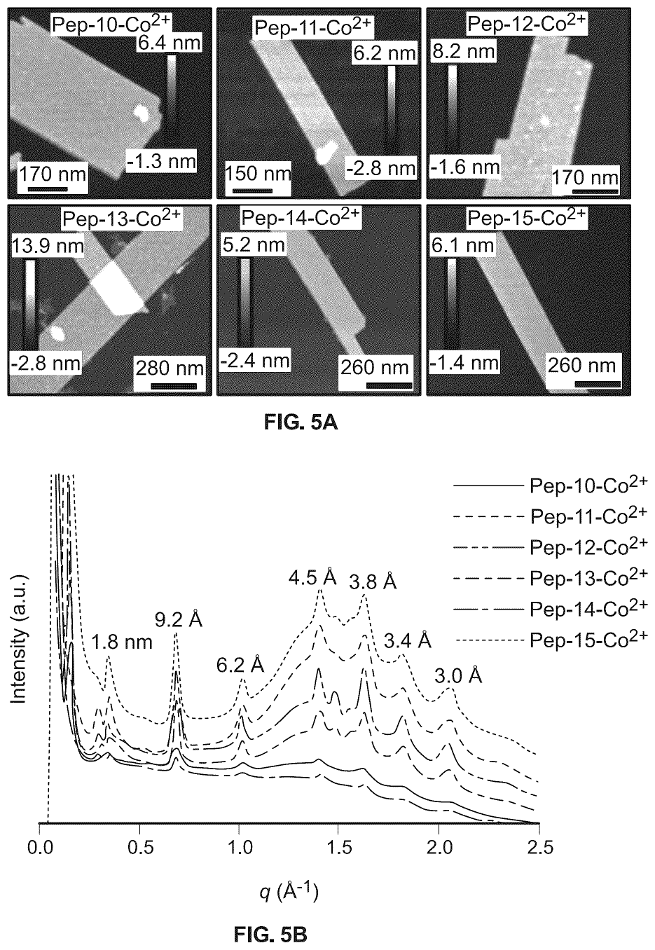

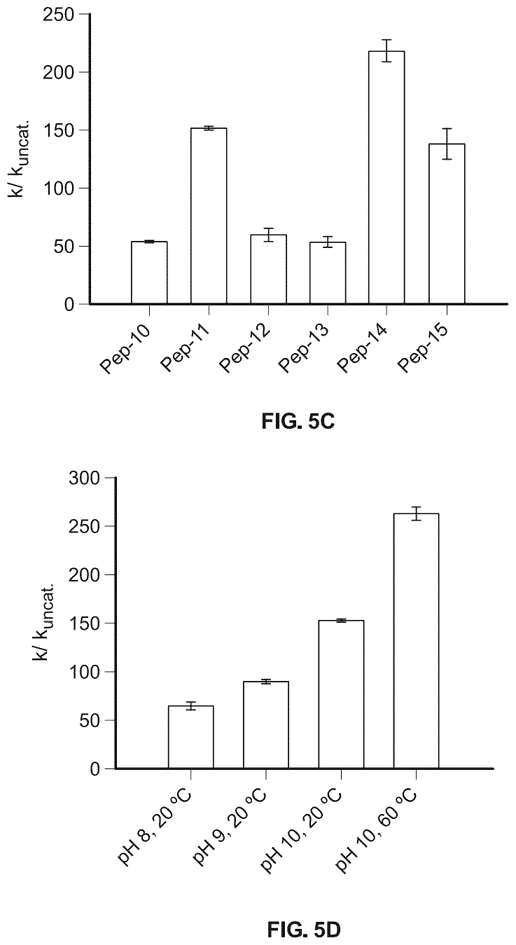

FIGS. 1E and 1F illustrate tuning the microenvironment of metal-containing peptoid membrane 300d, 300e by changing the side chain chemistry. As shown, introducing amino groups (—NH₂) into the hydrophilic domain emulates the presence of basic amino acid residues located adjacent to the active site of PTE. The metal-containing membranes with amino groups in the hydrophilic domain (shown in FIGS. 1E and 1F) exhibited superior activity to those with —COOH and —OCH₃ groups. The inclusion of —NH₂ groups can modulate the alkaline pH environment surrounding the metal active site, facilitating water deprotonation and enabling the generation of the active species metal(II)—OH⁻. The —NH₂ groups can contribute to the regeneration of the active site after each catalytic cycle by generating hydroxyl anions. In some embodiments, the metal-containing peptoid membranes 300 mimic the active site of PTE, which consists of a binding pocket composed of hydrophobic residues. Because of this, introducing Npm side chains near the metal center can remarkably enhance the catalytic activity. This enhancement is demonstrated in comparing the catalytic performance of Pep-10, Pep-11, Pep-12, Pep-13, Pep-14 and Pep-15 and is shown in FIG. 5C. This demonstrates the essential role of having hydrophobic groups in the proximity of the active site, enabling π-π interactions with organophosphates and accelerating the hydrolysis process. These findings highlight the exceptional tunability and versatility of metal-containing peptoid membranes as enzyme mimetics for the efficient degradation of organophosphates.

### EXAMPLES

The invention is further illustrated by the following examples. Various other aspects, modifications, and equivalents thereof which, after reading the description herein, can suggest themselves to one of ordinary skill in the art without departing from the spirit of the present invention or the scope of the appended claims.

### Characterization of Metal-Containing Peptoid Membranes:

In order to produce metal-containing peptoid membranes with precisely placed metal ions that can form metal complexes to mimic enzyme active sites, a variety of metal-coordination ligands were designed. As described herein, the metal-binding ligand and the adjacent hydrophilic units were varied on representative example peptoid membranes with a hexapeptoid hydrophobic domain. Peptoids were synthesized as describes below. These representative peptoids contain six Nbrpe (N-([2-(4-bromophenyl)ethyl]glycine)) in the hydrophobic domain and a varied number of Nce (N-(2-carboxyethyl)glycine) in the hydrophilic domain. The presence of six Nbrpe units has been demonstrated to be favorable for nanomembrane formation to form a crystalline hydrophobic core based on enhanced aromatic stacking interactions. Three different ligands, based on Npy, Nqn, and Do3a units were used to create metal binding sites, generating peptoids Pep-1 through Pep-6. As would be appreciated by those of skill in the relevant art, the backbone length and a non-coordinating side chain located adjacent to an active site within the peptoid chain has significant impacts on the catalytic reactions. Thus, Pep-7 to Pep-15 with varying backbone lengths and side chain chemistries were designed and synthesized. Detailed synthesis and characterizations of these peptoids, including their UPLC-MS data, are described herein. Notably, during the synthesis of Pep-5 and its derivatives (Pep-7-Pep-15) an unanticipated side reaction occurred which involved the formation of an unusual cyclic product in very high yield. Particularly, in the acylation step, the intermediate tris-bromoactylated peptoid underwent an intramolecular cyclization reaction with the N-terminal tertiary amine in the linker domain, resulting in a quaternary salt of a cyclic monoketopiperazine. It is likely that this reaction results in a mixture of two regioisomers as shown in the schematic below, where R₅ is (Nbrpe)₆(Nce)₆, (Nbrpe)₆(Nome)₆, or (Nbrpe)₆(Nae)₆.

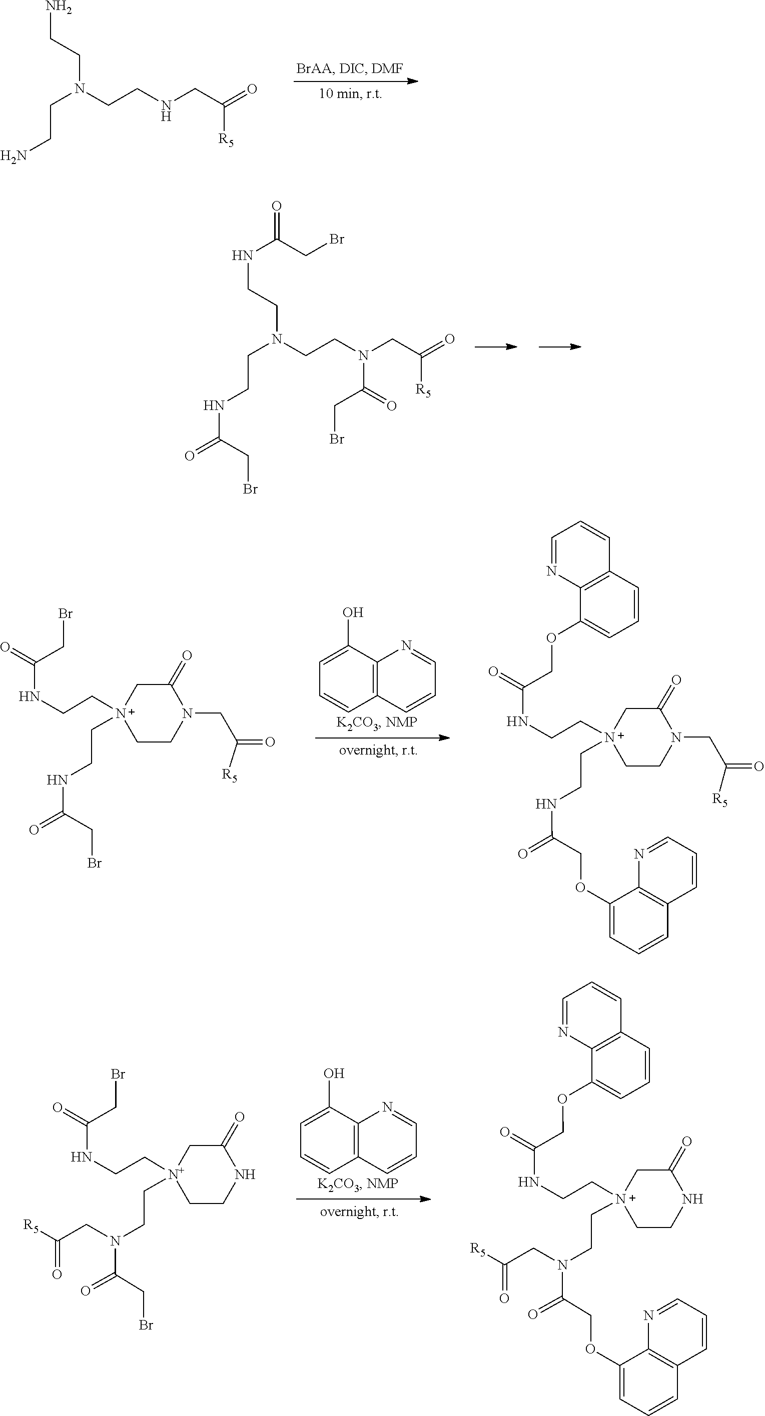

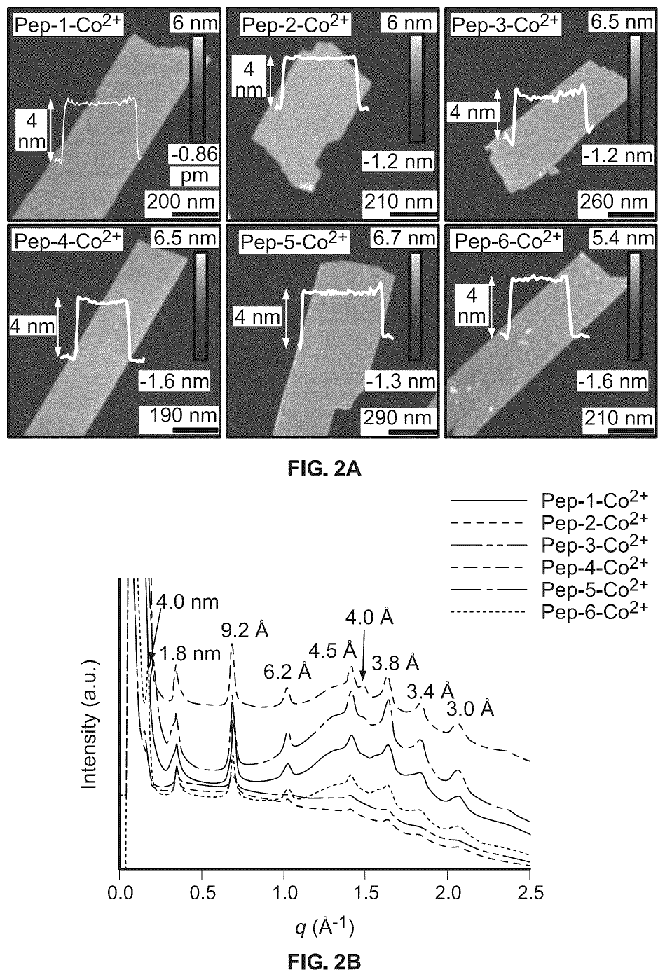

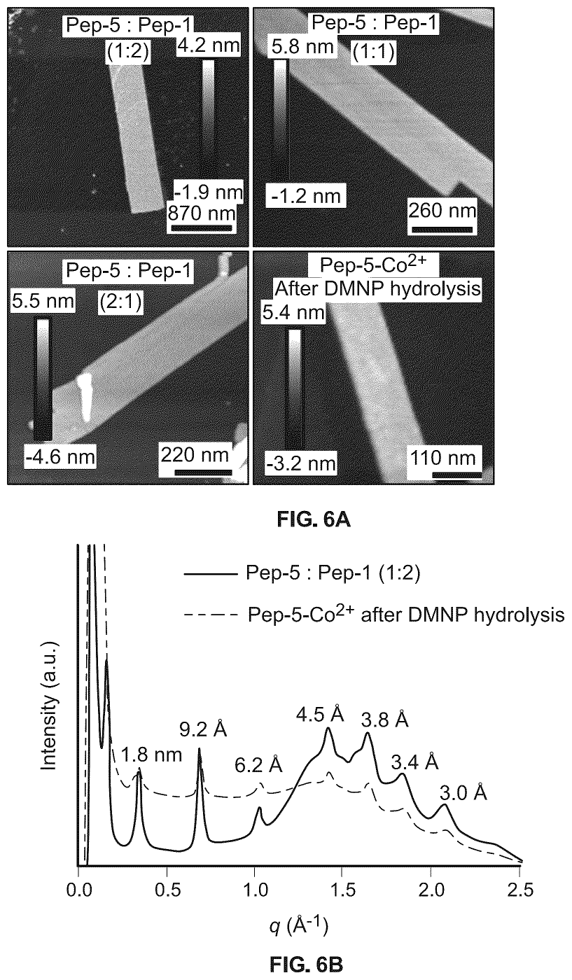

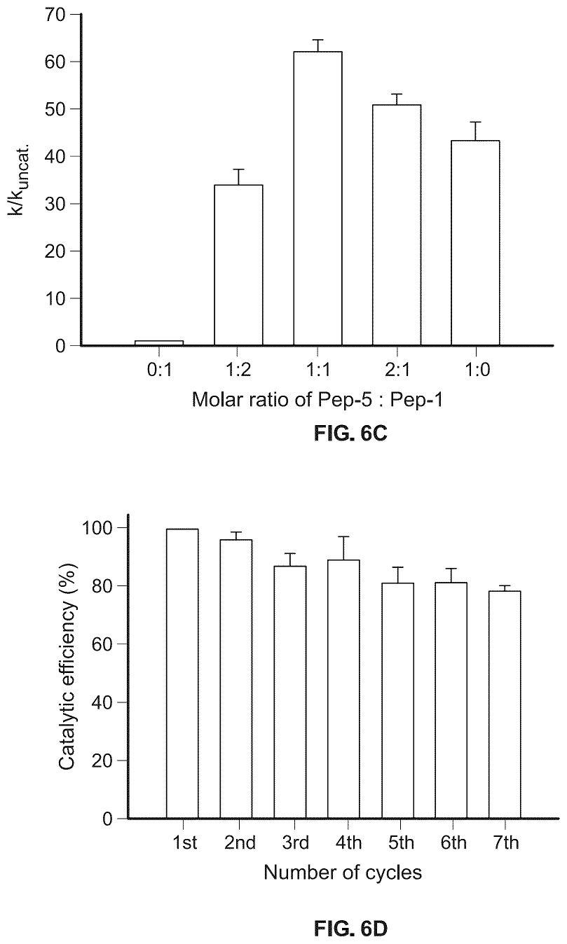

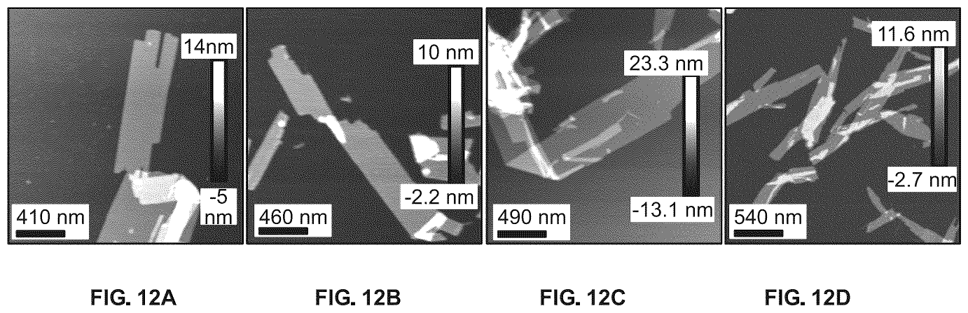

To obtain Co²⁺-containing nanomembranes, peptoids were mixed with Co(BF₄)₂ in water:acetonitrile=1:1 (v/v), followed by slow evaporation at 4° C. to induce the crystallization of the Nbrpe hydrophobic block. As shown in FIGS. 2A, 4B, 5A, 6A, and 12A-12D, atomic force microscopy (AFM) images clearly illustrated that all peptoids assembled into 2D nanomembranes. FIG. 2A shows topography of Co²⁺-containing Pep-1, Pep-2, Pep-3, Pep-4, Pep-5, and Pep-6. FIG. 4B shows topography of Co²⁺-containing Pep-7, Pep-8, and Pep-9. FIG. 5A shows topography of Co²⁺-containing Pep-10, Pep-11, Pep-12, Pep-13, Pep-14, and Pep-15. FIG. 6A provides topography of peptoid-Co²⁺ membranes include those assembled from various mixtures of Pep-5 and Pep-1, as well as the Pep-5-Co²⁺ membrane after the 3^{rd} catalytic cycle. FIGS. 12A-12D evaluate topography of Co²⁺-containing peptoid membranes under harsh conditions ranging from 60° C. for 2 hours (FIG. 12A), heat at 90° C. for 2 hours (FIG. 12B), in ethanol for 2 hours (FIG. 12C), and in 20 mM NEM at pH 10 for one week (FIG. 12D).

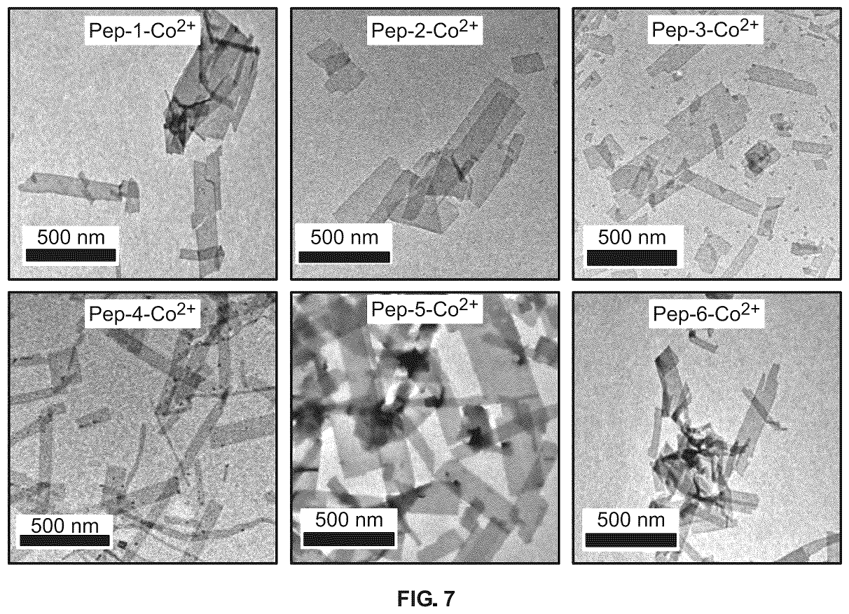

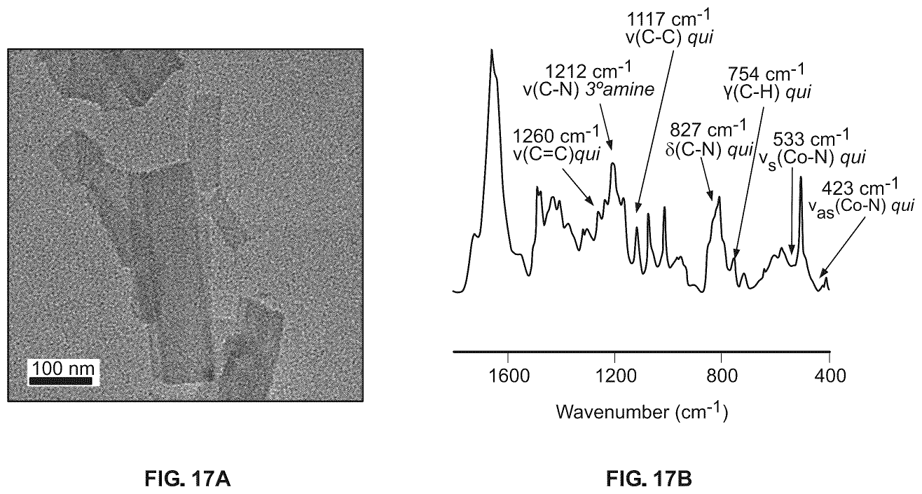

Similarly, FIGS. 4C, 7, 16, and 17A provide transmission electron microscopy (“TEM”) illustrating the peptoid membranes self-assembled into 2D membranes. FIG. 4C shows TEM images of Co²⁺-containing Pep-5, Pep-7, Pep-8, and Pep-9. FIG. 7 is TEM images of Co²⁺-containing Pep-1, Pep-2, Pep-3, Pep-4, Pep-5, and Pep-6. FIG. 16 is TEM images of Co²⁺-containing Pep-10, Pep-11, Pep-12, Pep-13, Pep-14, and Pep-15. FIG. 17A is a TEM image of Co²⁺-containing Pep-5 after the 3^{rd} catalytic hydrolysis cycle. The TEM images illustrate the well-defined shapes of the metal-containing peptoid membranes before and after hydrolysis.

To further investigate the self-assembled membrane structures, X-ray diffraction (XRD) characterization was conducted to demonstrate the generation of highly crystalline materials. FIG. 2B provides XRD spectra of Co²⁺-containing Pep-1, Pep-2, Pep-3, Pep-4, Pep-5, and Pep-6. FIG. 4D is XRD spectra of Co²⁺-containing Pep-7, Pep-8, and Pep-9. FIG. 5B provides XRD spectra of Co²⁺-containing Pep-10, Pep-11, Pep-12, Pep-13, Pep-14, and Pep-15.

The characteristic peaks found at 4.5, 3.4, 3.8 Å and 1.8 nm were attributed to the spacing of peptoid chains between peptoids, the distance between each residue aligned along the chain direction, the presence of π-stacking and the distance between adjacent backbones, respectively. The spacing of 3.0 Å is corresponding to the distance between each residue along the backbone chain direction. These XRD results show that functionalizing N-terminus with a wide variety of ligands with bound metal ions (e.g., Co²⁺, Cu²⁺, Zn²⁺, and the like) readily yields functionalized membranes with similar framework structures, further confirming the high tunability of these 2D nanomaterials for biomimetic catalysis. The peak at 4 nm likely corresponds to the membrane thickness. Representative example peptoid membranes (Pep-1-Pep-15) thickness was measured to be around 4 nm. As discussed above, the thickness of peptoid membranes can be altered based on the number of hydrophobic units and/or hydrophilic units that make up peptoid.

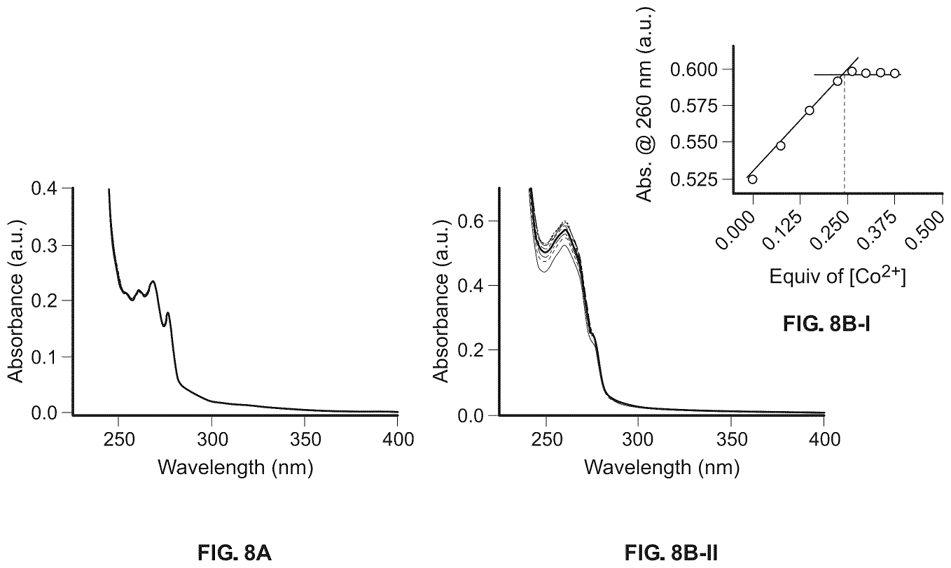

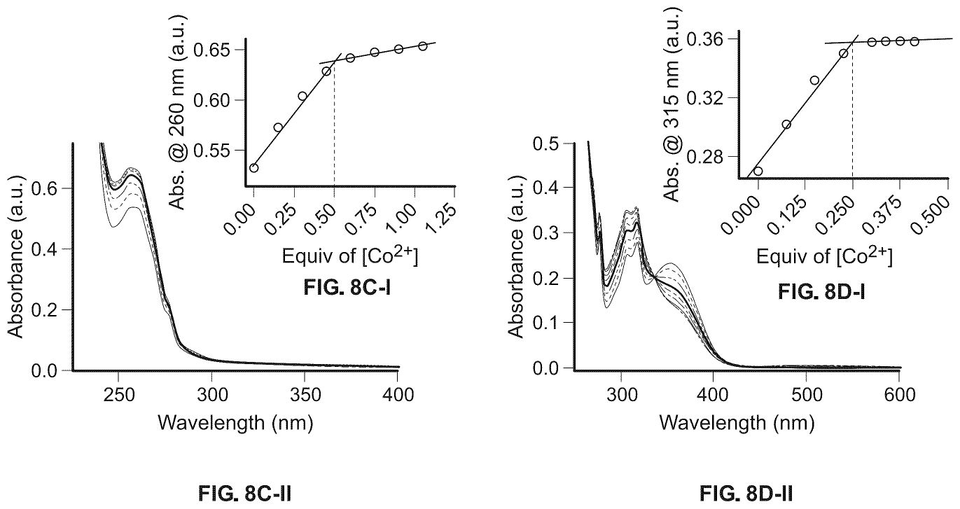

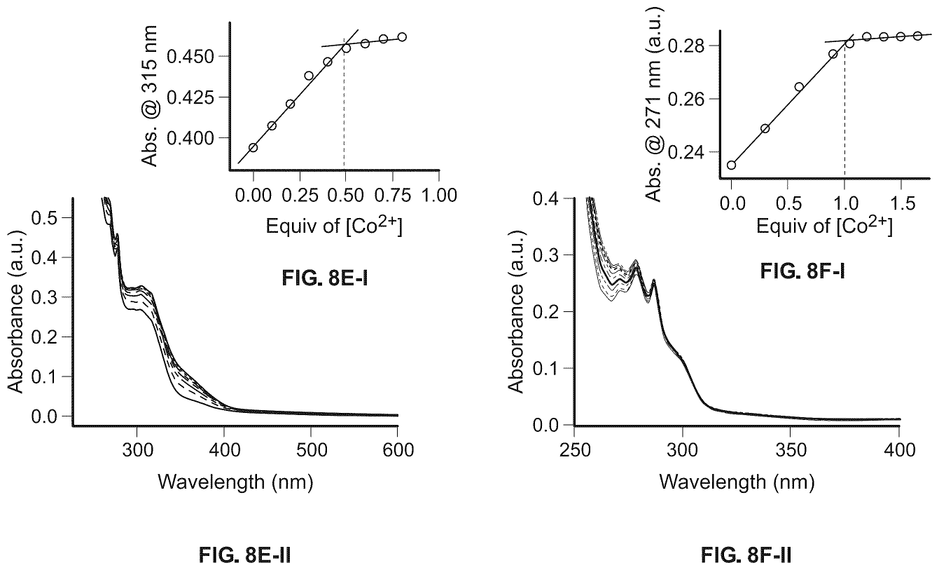

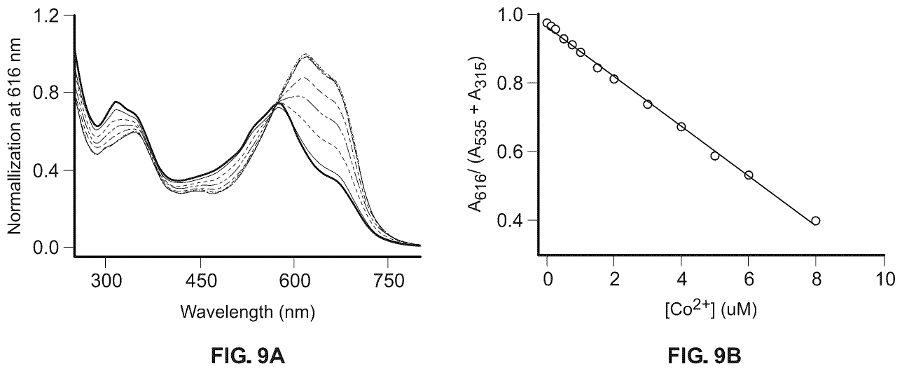

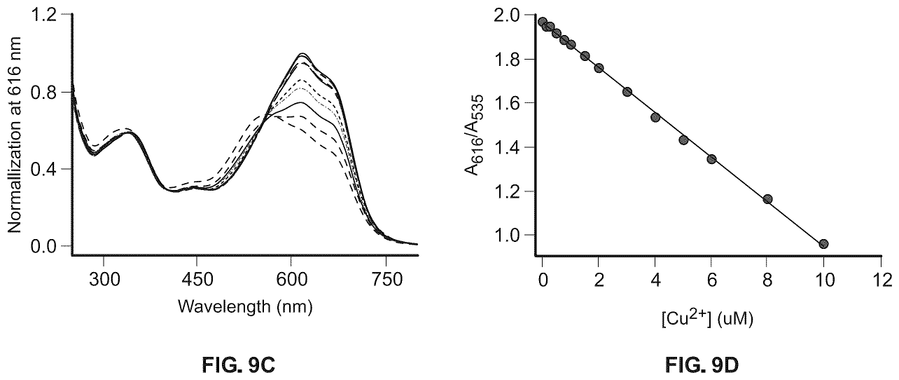

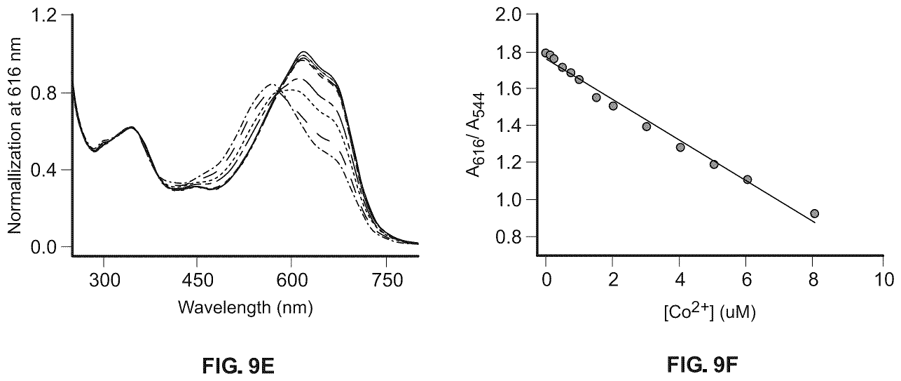

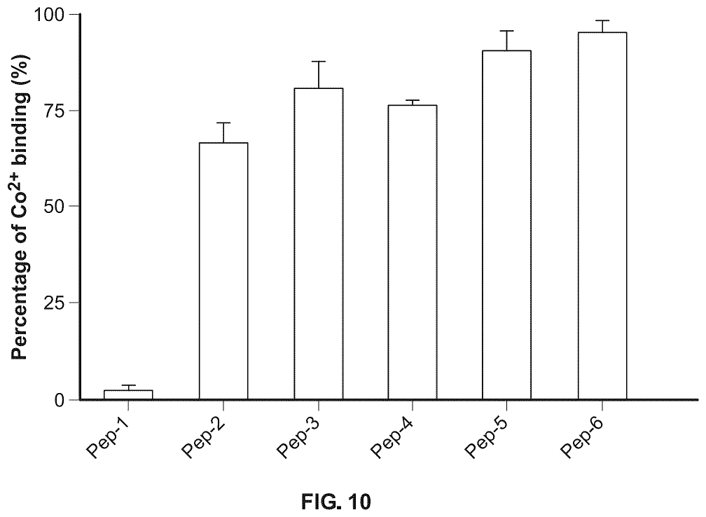

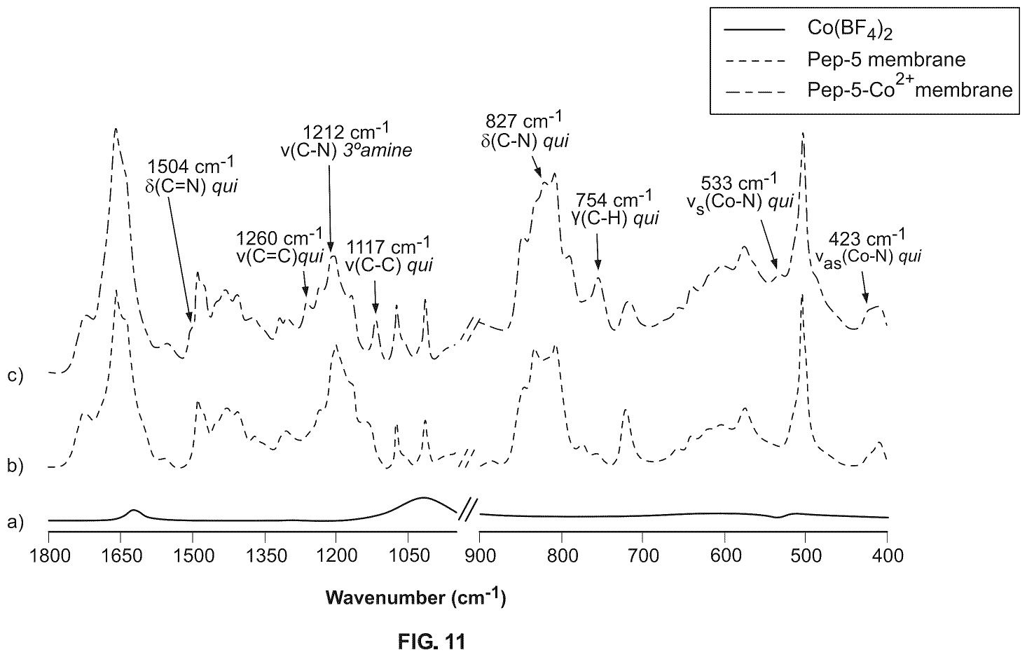

To validate the coordination between metal ions and peptoids within the peptoid membranes, ultraviolet-visible (UV-vis) and Fourier transform infrared (FT-IR) spectroscopy studies were performed. The ability of Co²⁺ to form a complex with free peptoids in the solution was investigated. Upon addition of Co(BF₄)₂ to peptoid solutions in acetonitrile, the absorbance at 260 nm for Pep-2 and Pep-3, 315 nm for Pep-4 and Pep-5, and 271 nm for Pep-6 showed an increase, indicating the formation of peptoid-Co²⁺ complexes (FIGS. 8A-8F). The titration results were used to construct metal-to-peptoid ratio plots, which revealed binding stoichiometry of peptoid: Co²⁺ as 1:0.25 (for Pep-2 and Pep-4), 1:0.5 (for Pep-3 and Pep-5), and 1:1 (for Pep-6). The binding of Co²⁺ with peptoids to form membranes was also investigated. The membranes were prepared by co-assembling Co²⁺ with the corresponding peptoids, following the binding ratios mentioned earlier. The amount of metal ions bound to the peptoid membranes was determined using Eriochrome Black T as a complexometric indicator. The results demonstrated that 65% to 95% of the initially added metal was bound to the assembled membranes (FIGS. 9A-9F and FIG. 10). Besides, appearance of the characteristic bands at 533 and 423 cm¹ in the FTIR spectrum of Pep-5-Co²⁺ membrane assigned to υ (Co—N) provides further evidence for chelation of peptoid and metal (FIG. 11). To confirm these Co²⁺-containing peptoid membranes are stable and suitable for catalytic degradation of organophosphates, the membrane stability was tested under a variety of conditions, including exposure to elevated temperatures and organic solvents. Peptoid membranes were found to remain intact after heating their aqueous solution to 60 and even 90° C. for over 2 h. They also showed good stability in ethanol for 2 h and in N-ethylmorphine (20 mM, pH=10) for over a week. The high stability results allow us to investigate the catalytic activity of these nanomembranes in a range of conditions as well as reuse them for the degradation of organophosphates.

### Catalytic Activity of Metal-Containing Peptoid Membranes:

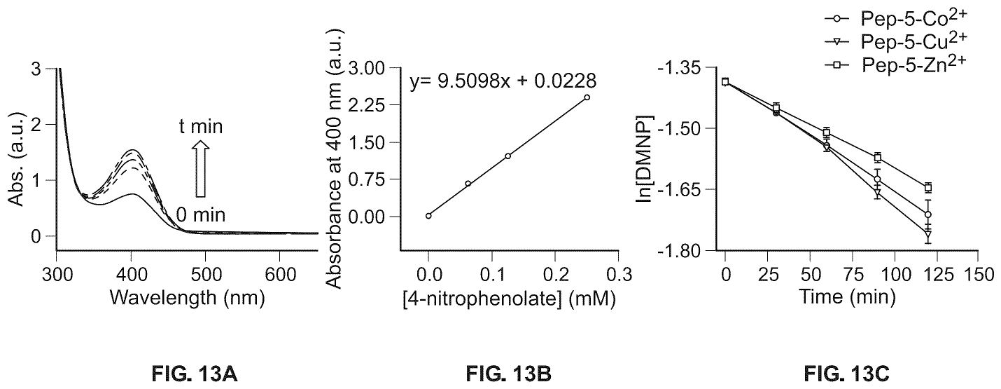

The catalytic efficiency of the metal-containing peptoid membranes was evaluated in an aqueous solution against an example organophosphate, dimethyl 4-nitrophenyl phosphonate (DMNP), by UV-vis to monitor the release of p-nitrophenolate (λ_{abs}=400 nm), as shown in FIGS. 13A-13C. Membrane solutions were assayed at a peptoid concentration of 0.125 mM and a DMNP concentration of 0.25 mM. To enable rapid screening, all reactions were conducted in 96-well plates and read in a commercial microplate reader. This method requires less than 200 μg of the material and can examine many different catalysts and conditions in a rapid time frame and in a high-efficiency manner.

### Effect of Ligand Chemistry:

Because the coordination of ligands with metal centers is a key feature of metalloenzyme active sites, such as PTEs, different ligands were used to coordinate with metal ions to mimic active sites of natural enzymes. Peptoid sequences (Pep-1-Pep-6) were synthesized as described herein with different numbers and chemistries of ligands, Npy, Nqn, and Do3a. The Co²⁺ cation was selected because of a notable enhancement in the activity of PTE when native Zn²⁺ was substituted by Co²⁺. The catalytic activities of Co²⁺-containing peptoid nanomembranes made from Pep-1 to Pep-6 were tested in NEM buffer (pH 10) at room temperature.

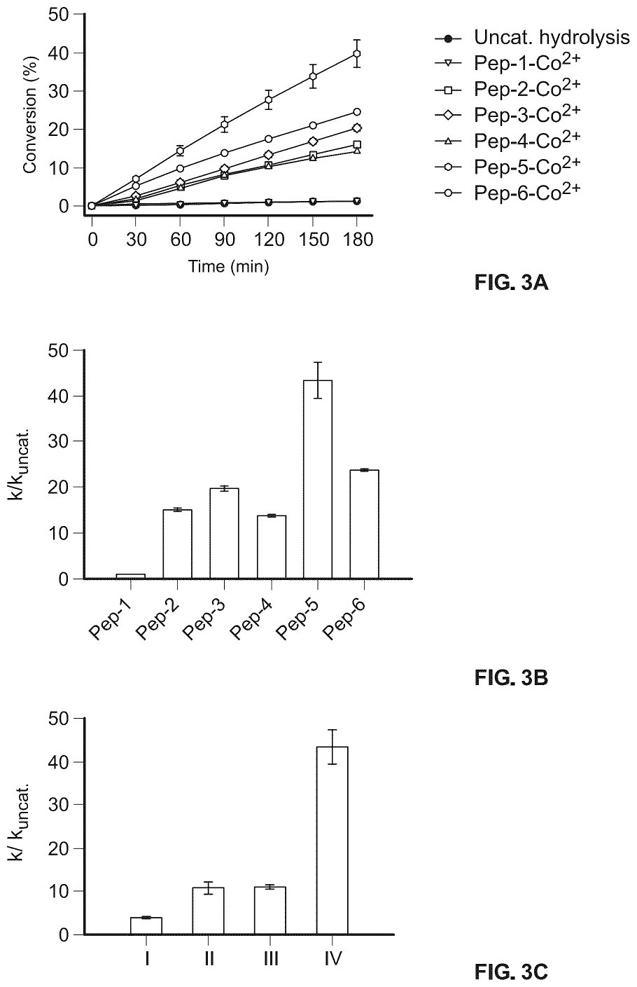

FIG. 3A illustrates the conversion profile of DMNP catalyzed by the Co²⁺-containing membranes. Direct analysis reveals variable first-order rate constants, turnover number (TON), and turnover frequency (TOF), as described in Table 1. Negligible catalytic performance was found with Pep-1-Co²⁺, similar to the uncatalyzed background hydrolysis reaction (FIG. 3B). In contrast, significant catalytic enhancements relative to the background (kc=65.3×10⁻⁶ min¹, Table 1, entry 1) were observed with all of the other peptoids. The observed activity acceleration followed the order Pep-4-Co²⁺ (13.7-fold)≤Pep-2-Co²⁺ (15.0-fold)<Pep-3-Co²⁺ (19.6-fold)<Pep-6-Co²⁺ (23.7-fold)<Pep-5-Co²⁺ (43.3-fold) (Table 1, entries 2-7) These results indicate that the introduction of an optimal ligand can greatly impact rate enhancement. The most efficient peptoid membrane catalyst in this set is Pep-5-Co²⁺ membranes where the ligand of Pep-5 consists of two Nqn groups.

### Effect of Peptoid-Co²⁺ Membrane Crystallinity:

FIG. 3C demonstrates the importance of the high crystallinity of metal-containing peptoid membranes in organophosphate hydrolysis. In particular, the effect of peptoid membrane crystallinity and ordering of metal ions on the surface were conducted with using amorphous aggregates of Pep-5-Co²⁺ complexes undergoing DMNP degradation. The amorphous aggregates were prepared by rapidly mixing Pep-5 with Co(BF₄)₂ in acetonitrile solvent, followed by lyophilization and resuspension in a NEM buffer. When this material was used for DMNP hydrolysis, it displayed a hydrolytic activity that was 11.4-fold lower than that of crystalline Pep-5-Co²⁺ membranes (see Table 1, entry 8). To ensure the binding of ligands with Co²⁺ cations and further highlight the importance of membrane crystallinity in DMNP degradation, another Pep-5-Co²⁺ complex sample was prepared by incubating Pep-5 with Co(BF₄)₂ for a week to ensure the coordination of Nqn ligands with Co²⁺. This second sample also displayed considerably reduced hydrolytic activity in contrast to the crystalline Pep-5-Co²⁺ membranes (see Table 1, entry 9), yet it closely resembled the activity of the soluble NpmNqn₂-Co²⁺ complex, which mimics the active site of Pep-5-Co²⁺ (see Table 1, entry 10). These findings suggest the ordering of ligand-Co²⁺ active sites as a result of membrane crystallinity, which can generate high efficiency in organophosphate hydrolysis.

To highlight the importance of the membrane catalyst preparation process, Co²⁺-free Pep-5 membranes were incubated with an aqueous solution of Co(BF₄)₂ for a week. This obtained Pep-5 membrane-Co²⁺ complex exhibited a k_{cat}/k^{uncat} of 11 (see Table 1, entry 11), which is 3.9-fold lower than that of crystalline Pep-5-Co²⁺ membranes. The close packing of Nqn ligands within Co²⁺-free Pep-5 membranes may limit the efficiency of coordinating with Co²⁺, thus reducing the number of ligand-Co²⁺ active sites as well as their ordering within membranes for catalytic organophosphate hydrolysis. In conclusion, the coassembly of peptoids and Co²⁺ cations to form crystalline Pep-5-Co²⁺ membranes was found to be the best way to produce highly active membrane catalysts.

### Effect of Metal Cations:

FIGS. 13A through 13C show measurements evaluating catalytic efficiency of metal-containing peptoid membranes. In particular, FIG. 13A shows representative changes in UV/vis spectra of DMNP hydrolysis reaction. FIG. 13B shows calibration curve of 4-nitrophenolate in [NEM]=20 mM at pH=10. FIG. 13C shows kinetic profiles of peptoid membranes with different metal ions. In general, metal cations such as Zn²⁺ or Cu²⁺ can act as Lewis acids to catalyze hydrolysis reactions. As would be understood by one of skill in the relevant art, the choice of metal cation plays an important role in organophosphate hydrolysis catalyzed by metal-containing peptoid membranes. Accordingly, other transition metal ions, such as Cu²⁺ and Zn²⁺ are contemplated for metal-containing peptoid membranes. For example, metal-containing Pep-5 membranes were synthesized in the presence of Cu²⁺ or Zn²⁺ using the assembly methods described herein. The hydrolytic activity of such metal ions was studied and compared for organophosphate hydrolysis of DMNP.

In kinetic profiles depicted in FIG. 13C, crystalline Pep-5-Cu²⁺ membranes exhibited an increased activity (k_{cat}/k_{uncat}=49.0) compared to crystalline Pep-5-Co²⁺ membranes (k_{cat}/k_{uncat} of 43.3), while Pep-5-Zn²⁺ membranes displayed a slight reduction in hydrolytic activity (k_{cat}/k_{uncat} of 32.7; see Table 1, entries 12 and 13) reactivity.

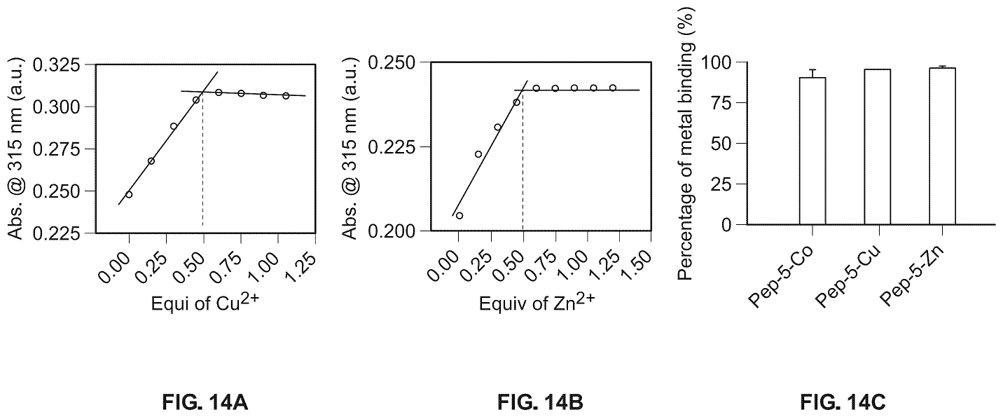

FIGS. 14A and 14B demonstrate kinetics of increase in absorbance of Pep-5 upon adding given amounts of different metal cations and FIG. 14C compares percentage of metal binding. As shown, both Cu²⁺ and Zn²⁺ bound to Pep-5 with a 0.5 molar ratio, and the amounts of metals loaded were 95 and 96% for Pep-5-Cu²⁺ and Pep-5-Zn²⁺, respectively, which are comparable to that of Pep-5-Co²⁺. Differences in the rate enhancement could be due to the electronegativity of the metal cations, which also increases following the order Zn²⁺ (χ=1.65)<Co²⁺ (χ=1.88)<Cu²⁺ (χ=1.90). The selection of metal cations with a higher electronegativity leads to a better catalytic activity for organophosphate hydrolysis. The catalytic activity of metal-containing peptoid membranes can be further optimized by using metal cations possessing a higher electronegativity.

### Effect of Hydrophilic Linker Length:

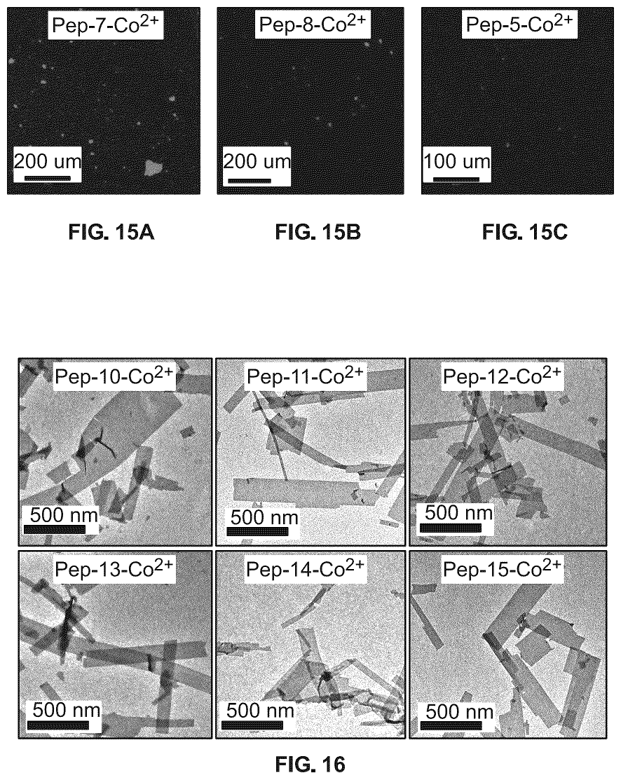

To explore the impact of the hydrophilic linker length of peptoids on membrane hydrolytic activity, Pep-7-Pep-9 were synthesized as a series of Pep-5 derivative peptoids containing different numbers (n) of Nce groups. As depicted in FIG. 4A, all Co²⁺-containing peptoid membranes are effective in DMNP degradation. Among them, membranes assembled from Pep-5 with n=6 Nce groups displayed the highest efficiency. Conversely, membranes assembled from sequences with fewer Nce groups (Pep-7, n=0; Pep-8, n=3) or more Nce groups (Pep-9,n=9) exhibited lower efficiency in DMNP degradation (see Table 1, entries 14-16). These findings suggest that maintaining an optimal distance between Nqn-Co²⁺ active sites and the hydrophobic cores of peptoid membranes can be tuned for achieving a high catalytic efficiency. FIGS. 4B and 4C provide the morphologies of these peptoid membranes with AFM and TEM characterization, respectively. Both AFM and TEM results showed that while both Pep-8 and Pep-9 formed nice nanomembranes as Pep-5 did in the presence of Co²⁺ cations. Similarly, FIG. 4D provides XRD data of Pep-8-Co²⁺ and Pep-9-Co²⁺ membranes that have similar patterns, whereas Pep-7 with n=0 formed multilayer membrane structures and an obvious difference in some XRD peaks. FIGS. 15A-15C provide fluorescent microscopy images of these peptoid-Co²⁺ membranes, which further confirmed the dramatic feature of the Pep-7-Co²⁺ membranes by showing the largest aggregation among the Pep-5-Co²⁺, Pep-7-Co²⁺, and Pep-8-Co²⁺ membranes. Because the metal centers are positioned on the membrane surface, this multilayer stacking of membranes likely limited the exposure of Nqn-Co²⁺ active sites of peptoid membranes, thereby reducing its catalytic efficiency. These results indicate that the presence of the appropriate linker promotes the formation of free-standing nanomembranes with the maximum exposure of ligand-metal actives for catalysis.

### Effect of the Active Site Microenvironment:

In natural enzymes, the microenvironment surrounding their metal-ligand active sites plays a key role in regulating the catalytic reactions. To modulate the microenvironment of Nqn-Co² active sites, Pep-10 was synthesized to have all Nce groups replaced with Nome (Nome=N-(2-methoxyethyl)glycine) and Pep-11 with all Nae (Nae=N-(2-aminoethyl)glycine) groups in the polar domain.

FIGS. 5A and 16 provide AFM and TEM results which confirm the formation of peptoid membranes. FIG. 5B provides XRD results showing these peptoid membranes as highly crystalline with peaks almost identical to those of other Co²⁺-containing peptoid membranes, suggesting a similar framework structure. FIG. 5C shows DMNP hydrolysis results where Pep-10-Co²⁺ exhibited an acceleration of k_{cat}/k_{uncat}=53.7, which is slightly higher than that of Pep-5-Co²⁺ membranes (k_{cat}/k_{uncat}=43.3), while Pep-11-Co²⁺ membranes showed a 152-fold acceleration (k_{cat}/k_{uncat}=152) (see Table 1, entries 17 and 18). These results confirm the important role of amino groups in the design of peptoid membranes effective for catalytic degradation of organophosphates.

To test if the number and position of Nae groups are important for the catalytic DMNP degradation, Pep-12 and Pep-13 were synthesized to contain four Nome and two Nae groups but in different positions. In the presence of Co²⁺, both peptoids formed crystalline peptoid-Co²⁺ membranes with structures similar to Pep-11-Co²⁺ membranes. FIG. 5C show DMNP degradation results suggesting that reduced numbers of Nae groups can lead to a decreased efficiency of peptoid-Co²⁺ membranes for DMNP degradation, suggesting that the number of amino groups in the membrane catalysts is more important than their locations in affecting the organophosphate hydrolytic activity (see Table 1, entries 19 and 20).

To mimic such a local hydrophobic environment to facilitate the binding with organophosphates, Pep-14 was designed and synthesized by including aromatic Npm [Npm=N-(1-phenylmethyl)glycine]adjacent to the Nqn ligand. As expected, the assembly of Pep-14 in the presence of Co²⁺ led to the formation of similar and highly crystalline Co²⁺-containing membranes confirmed by AFM and XRD results of FIGS. 5B and 5C. Interestingly, Pep-14-Co²⁺ membranes showed a nearly 219-fold acceleration in DMNP degradation (k_{cat}/k_{uncat}=219; see Table 1, entry 21), suggesting the important role of the Npm-created microenvironment in promoting the catalytic efficiency. This increase is likely due to the increased interaction of DMNP with Npm groups through π-π interaction. Pep-15 was synthesized by replacing Npm with a Nip [Nip=N-(isopropyl)glycine]group. As shown in FIG. 5C, while Pep-15 formed a similar Co²⁺-containing membrane as Pep-14 did, this membrane showed an almost identical hydrolysis activity to Pep-11-Co²⁺ membranes (see Table 1, entry 22), highlighting the important role of the local aromatic hydrophobic environment in the development of peptoid membrane catalysts for efficient organophosphate degradation.

### Effect of pH and Temperature:

While natural enzymes are only active in the narrow physiological pH ranges, our Co²⁺-containing peptoid membranes are highly robust and can be used under a wide range of conditions, such as different solution pH and elevated temperature, for catalytic performance. Solution pH and temperature have a significant influence in the organophosphate hydrolysis triggered by PTEs and biomimetic catalysts. For this reason, Pep-11-Co²⁺ membrane-based DMNP hydrolysis was performed in NEM buffer at three different solution pH (i.e., pH 8, pH 9, and pH 10) and also at an elevated temperature of 60° C. FIG. 5D shows hydrolysis results showing the increase of solution pH leading to an increase in the hydrolysis rate following the order pH 8 (63.6-fold)<pH 9 (89.1-fold)<pH 10 (152-fold; see Table 1, entries 18, 23, and 24).

The rate-determining step involves the nucleophilic attack of a hydroxide ion on the phosphorus center after the substrate binds with the metal ion. Unlike previous Zn²⁺ or Ag⁺ complexes owning hydroxyl groups next to the coordination site, acting as effective internal nucleophiles, the absence of this nucleophile close to the metal center of the peptoids leads to water being the sole source of external nucleophiles. Accordingly, the pH needs to be high enough to afford an adequate amount of aqueous hydroxide ions and thus to realize rapid OP hydrolysis. PTEs with either native zinc ions or non-native metal ions showed good OP hydrolysis activities at T≤35° C. In contrast, Pep-11-Co²⁺ membranes were able to achieve a nearly 261-fold rate enhancement when they were used at 60° C. and pH 10 (see Table 1, entry 25), while most natural enzymes like PTEs denatured under these conditions. An accelerating reaction rate may involve the increasing collision of molecules, speeding up the mass transfer rate and thus improving the hydrolysis. These results show that peptoid membrane catalysts are highly robust and can provide a much larger window for biomimetic degradation of organophosphates and open the way for potential practical applications.

### Effect of Active Site Density:

To investigate how the density of Nqn-Co²⁺ active sites affects the hydrolytic activity, Pep-5 was coassembled with Pep-1 (having no metal-coordination ligand) at various molar ratios of 1:2, 1:1, and 2:1 in the presence of Co(BF₄)₂ to obtain peptoid-Co²⁺ membranes with various densities of Nqn-Co²⁺ active sites. Both AFM and XRD results provided strong evidence that the membrane morphology and crystallinity are not affected by the variation of peptoid ratios for cocrystallization (FIGS. 6A and 6B).

FIG. 6C shows DMNP hydrolysis results demonstrating that peptoid-Co²⁺ membranes coassembled from Pep-5 and Pep-1 with a molar ratio of 1:1 showed the highest efficiency in hydrolytic activity with a k_{cat}/k_{uncat}=62.2 (see Table 1, entries 26-28), further reducing the molar ratio of Pep-5 during the membrane formation and leading to the decreased hydrolytic activity. These phenomena can be attributed to the following reasons. (1) Within the crystalline Pep-5-Co²⁺ membranes, a high density of orderly packed Nqn-Co²⁺ active sites could limit the access of DMNP for degradation. When the density of the active sites decreased, the diffusion of DMNP and its degraded product is increased, thus leading to increased hydrolytic activity. A further decrease of Nqn-Co²⁺ density below a 1:1 molar ratio of Pep-5 to Pep-1 reduced the hydrolytic activity, which could be due to the insufficient active sites available for binding with the phosphorus center of organophosphates for the cleavage of phosphate ester bonds. (2) The binding study results shown in FIGS. 8A through 8F show that one Co²⁺ cation can coordinate with two Pep-5 to form a complex; thus, a further decrease of Pep-5 to have a high content of Pep-1 (1:2 ratio) might create improper distances between Nqn, resulting in the reduced number of Nqn-Co²⁺ active sites to slow down the degradation activity.

### Catalytic Reusability:

To validate the reusability of our metal-containing peptoid membranes, seven consecutive catalytic cycles were performed using Pep-5-Co²⁺ membranes. After each hydrolysis cycle, the peptoid membranes were recovered by pelleting the catalyst via centrifugation and washing several times with water prior to the next use. After seven cycles, up to 80% of the first-order rate constant was still retained, compared to the first cycle utilization (FIG. 6D; see also Table 1, entries 6 and 29-34). FIGS. 6A and 17A provide AFM and TEM results, respectively, that show that Pep-5-Co²⁺ membranes remained intact after seven-cycle hydrolysis experiments. FIG. 6B provides XRD results which confirm the remaining high crystallinity and unchanged framework structure. Moreover, FT-IR spectrum in FIG. 17B shows the presence of Nqn-Co²⁺ active sites was also confirmed in the recovered membrane, further supporting the successful preservation of the Pep-5-Co²⁺ membranes. The reduced catalytic activity could be attributed to the inevitable mass loss of the membrane sample due to repeated water washing and centrifugation. These results showed that the highly crystalline and robust Pep-5-Co²⁺ membranes offer great potential as stable and recyclable catalysts for efficient organophosphate degradation.

TABLE 1
Summary of catalytic activities for example
peptoid membranes under various conditions.

| | | | | | TOF |
|---|---|---|---|---|---|
| | | | k_{cat} | | (×10⁻⁷ |
| No. | Catalyst | pH | (×10⁻⁶ min⁻¹) | k_{cat}/k_{uncat} | min⁻¹) |
| 1 | none | 10 | 65.3 ± 1.7 | 1 | — |
| 2 | Pep-1-Co²⁺ membrane | 10 | 54.2 ± 2.8 | 0.8 ± 0.04 | 1.2 |
| 3 | Pep-2-Co²⁺ membrane | 10 | 980 ± 27 | 15.0 ± 0.4 | 89 |
| 4 | Pep-3-Co²⁺ membrane | 10 | 1280 ± 33 | 19.6 ± 0.5 | 120 |
| 5 | Pep-4-Co²⁺ membrane | 10 | 897 ± 17 | 13.7 ± 0.2 | 70 |
| 6 | Pep-5-Co²⁺ membrane | 10 | 2830 ± 250 | 43.3 ± 3.9 | 690 |
| 7 | Pep-6-Co²⁺ membrane | 10 | 1550 ± 13 | 23.7 ± 0.2 | 310 |
| 8 | Amorphous Pep-5-Co²⁺ | 10 | 247 ± 17 | 3.8 ± 0.2 | 1.6 |
| 9 | Amorphous Pep-5-Co²⁺ | 10 | 701 ± 89 | 10.7 ± 1.4 | 15 |
| | complex | | | | |
| 10 | Soluble NpmNqn2-Co²⁺ | 10 | 615 ± 25 | 9.4 ± 0.4 | 29 |
| | complex | | | | |
| 11 | Pep-5 membrane-Co²⁺ | 10 | 720 ± 33 | 11.0 ± 0.5 | 60 |
| 12 | Pep-5-Cu²⁺ membrane | 10 | 3200 ± 150 | 49.0 ± 2.2 | 722 |
| 13 | Pep-5-Zn²⁺ membrane | 10 | 2140 ± 56 | 32.7 ± 0.8 | 451 |
| 14 | Pep-7-Co²⁺ membrane | 10 | 542 ± 8 | 8.3 ± 0.1 | 38 |
| 15 | Pep-8-Co²⁺ membrane | 10 | 764 ± 11 | 11.7 ± 0.1 | 79 |
| 16 | Pep-9-Co²⁺ membrane | 10 | 1470 ± 7 | 22.4 ± 0.1 | 260 |
| 17 | Pep-10-Co²⁺ membrane | 10 | 3510 ± 38 | 53.7 ± 0.6 | 280 |
| 18 | Pep-11-Co²⁺ membrane | 10 | 9900 ± 830 | 152 ± 1.7 | 5000 |
| 19 | Pep-12-Co²⁺ membrane | 10 | 3880 ± 380 | 59.3 ± 5.8 | 140 |
| 20 | Pep-13-Co²⁺ membrane | 10 | 3470 ± 290 | 53.1 ± 4.5 | 930 |
| 21 | Pep-14-Co²⁺ membrane | 10 | 14300 ± 620 | 219 ± 9.4 | 14100 |
| 22 | Pep-15-Co²⁺ membrane | 10 | 9040 ± 840 | 139 ± 12.9 | 5700 |
| 23 | Pep-11-Co²⁺ membrane | 9 | 5820 ± 150 | 89.1 ± 2.3 | 3100 |
| 24 | Pep-11-Co²⁺ membrane | 8 | 4150 ± 280 | 63.6 ± 4.3 | 1500 |
| 25 | Pep-11-Co²⁺ membrane, | 10 | 17050 ± 406 | 261 ± 6.2 | 14670 |
| | 60° C. | | | | |
| 26 | Pep-5-Pep-1-Co²⁺ (1:2) | 10 | 2210 ± 313 | 33.8 ± 4.8 | 579 |
| | membrane | | | | |
| 27 | Pep-5-Pep-1-Co²⁺ (1:1) | 10 | 4070 ± 149 | 62.2 ± 2.3 | 1270 |
| | membrane | | | | |
| 28 | Pep-5-Pep-1-Co²⁺ (2:1) | 10 | 3320 ± 150 | 50.8 ± 2.3 | 591 |
| | membrane | | | | |
| 29 | Pep-5-Co²⁺ membrane, | 10 | 2700 ± 77 | 41.5 ± 1.2 | 669 |
| | 2nd cycle | | | | |
| 30 | Pep-5-Co²⁺ membrane, | 10 | 2620 ± 122 | 40.3 ± 1.9 | 586 |
| | 3rd cycle | | | | |
| 31 | Pep-5-Co²⁺ membrane, | 10 | 2610 ± 224 | 40.2 ± 3.4 | 589 |
| | 4th cycle | | | | |
| 32 | Pep-5-Co²⁺ membrane, | 10 | 2550 ± 157 | 39.2 ± 2.4 | 510 |
| | 5th cycle | | | | |
| 33 | Pep-5-Co²⁺ membrane, | 10 | 2420 ± 132 | 37.2 ± 2.0 | 503 |
| | 6th cycle | | | | |
| 34 | Pep-5-Co²⁺ membrane, | 10 | 2400 ± 54 | 36.9 ± 0.8 | 499 |
| | 7th cycle | | | | |

### Materials, Synthesis, and Characterization of Compositions:

All solvents were bought from Fisher or VWR and used without further purification. Millipore ultrapure water was employed throughout the experiments. Rink Amide resin (0.7-1.0 meq/g) and bromoacetic acid were purchased from Chem-Impex International, Inc. Zinc tetrafluoroborate hydrate (Zn(BF₄)₂) and copper(II) tetrafluoroborate hexahydrate (Cu(BF₄)₂) were brought from Thermo Scientific./J-alanine tert-butyl ester hydrochloride was purchased from Oakwood Chemical and was deprotected following the previous protocol prior to use. 1 N,N′-diisopropylcarbodiimiide, 4-methylpiperidine, potassium carbonate (K₂CO₃), 4-bromophenyl ethylamine, tert-butyl-N-(2-aminoethyl)carbamate, 2-methoxyethyl amine and trifluoroactic acid (TFA) were purchased from Oakwood Chemical. Tris(2-aminoethyl)amine, 8-hydroxyquinoline (Nqn), N-ethylmorphine (NEM), Eriochrome Black T dye, cobalt(II) tetrafluoroborate hexahydrate (Co(BF₄)₂), dimethyl 4-nitrophenyl phosphonate (DMNP), and 4-(aminomethyl)pyridine (Npy) were purchased from Sigma-Aldrich. 1,4,7,10-Tetraazacyclododecane-1,4,7-triacetic acid (Do3a) was obtained from Ambeed, Inc. All amine submonomers were used as received.

Exemplary peptoids include, but are not limited to:

| Peptoid | Composition |
|---|---|
| Pep-1 | NH₂—(Nbrpe)₆(Nce)₆—H |
| Pep-2 | NH₂—(Nbrpe)₆(Nce)₆—Npy |
| Pep-3 | NH₂—(Nbrpe)₆(Nce)₆—Npy₂ |
| Pep-4 | NH₂—(Nbrpe)₆(Nce)₆—Nqn |
| Pep-5 | NH₂—(Nbrpe)₆(Nce)₆—Nqn₂ |
| Pep-6 | NH₂—(Nbrpe)₆(Nce)₆—Do3a |
| Pep-7 | NH₂—(Nbrpe)₆—Nqn₂ |
| Pep-8 | NH₂—(Nbrpe)₆(Nce)₃—Nqn₂ |
| Pep-9 | NH₂—(Nbrpe)₆(Nce)₉—Nqn₂ |
| Pep-10 | NH₂—(Nbrpe)₆(Nome)₆—Nqn₂ |
| Pep-11 | NH₂—(Nbrpe)₆(Nae)₆—Nqn₂ |
| Pep-12 | NH₂—(Nbrpe)₆(Nome)₄(Nae)₂—Nqn₂ |
| Pep-13 | NH₂—(Nbrpe)₆(Nae)₂(Nome)₄—Nqn₂ |
| Pep-14 | NH₂—(Nbrpe)₆(Nae)₆—Npm₂Nqn₂ |
| Pep-15 | NH₂—(Nbrpe)₆(Nae)₆—Nip₂Nqn₂ |

Synthesis of Pep-1 [NH₂-(Nbrpe)₆(Nce)₆-H]: 2232.92 (Molecular weight), 1117.84 (Found: [M/2+H]⁺). The synthesis of all peptoid sequences was carried out on Rink amide resins (Chem Impex) using solid-phase synthesis, following the procedures described in previous works. In detail, the Rink amide resins (100 mg, 0.09 mmol) were first swelled in N,N-dimethylformamide (DMF) for 10 minutes. Afterward, the resins were filtered, and the Fmoc groups were removed by adding 2 mL of 20% (v/v) 4-methylpiperidine/DMF solution. The mixture was then shaken at room temperature for 40 minutes. Subsequently, the resins were drained and washed with DMF using 5 washes of 1 mL each.

Afterward, the deprotected resins underwent an acylation reaction (Scheme Sla) using 1.5 mL of 0.6 M bromoacetic acid and 0.3 mL of a 50/50 (v/v) N,N-diisopropylcarbodiimide (DIC)/DMF mixture. The reaction mixture was shaken for 10 minutes at room temperature, followed by washing with DMF (5×1 mL). Nucleophilic displacement of bromide with the submonomers was achieved by adding 1.5 mL of a 0.6 M primary amine solution in N-methyl-2-pyrrolidone (NMP) and agitating for 10 minutes at room temperature. The solution was then filtered, and the resins were washed with DMF (5×1 mL). The acylation and displacement reactions with appropriate primary amines, such as 4-bromophenethylamine (which was used to generate Nbrpe) or beta-alanine tert-butyl ester (which was used to generate Nce) were repeated until the desired target peptoid sequence was obtained.

Synthesis of Pep-2 [NH₂-(Nbrpe)₆(Nce)₆-Npy]: 2380.94 (Molecular weight), 1191.77 (Found: [M/2+ H]⁺). Pep-2 was synthesized through the functionalization of Pep-1 using the submonomer procedure. Typically, Pep-1 (0.09 mmol, 1 equiv.) was mixed with 1.5 mL of 0.6 M chloroacetic acid and 0.3 mL of a 50/50 (v/v) DIC/DMF mixture for 10 minutes. The supernatant was then removed, and the resin was washed with DMF (5×1 mL). Next, 1.5 mL of 0.6 M 4-(aminomethyl)pyridine (Npy) in NMP was added to the resin. The mixture was stirred for 2 hours at 40° C., filtered, and washed with DMF (5×1 mL).

Synthesis of Pep-3 [NH₂-(Nbrpe)₆(Nce)₆-Npy₂]: 2528.84 (Molecular weight), 1264.92 (Found: [M/2+ H]⁺), 843.62 (Found: [M/3+H]⁺). Pep-3 was synthesized through the functionalization of Pep-2 using the submonomer procedure. Typically, Pep-2 (0.09 mmol, 1 equiv.) was mixed with 1.5 mL of 0.6 M chloroacetic acid and 0.3 mL of a 50/50 (v/v) DIC/DMF mixture for 10 minutes. After removing the supernatant, the resin was washed with DMF (5×1 mL). Next, 1.5 mL of 0.6 M Npy in NMP was added to the resin. The mixture was stirred for 2 hours at 40° C., filtered, and washed with DMF (5×1 mL).

Synthesis of Pep-4 [NH₂-(Nbrpe)₆(Nce)₆-Nqn]: 2417.50 (Molecular weight), 1210.54 (Found: [M/2+H]⁺). Pep-4 was synthesized through the functionalization of Pep-1 using the submonomer procedure. Typically, Pep-1 (0.09 mmol, 1 equiv.) was mixed with 1.5 mL of 0.6 M bromoacetic acid and 0.3 mL of a 50/50 (v/v) DIC/DMF mixture for 10 minutes. After removing the supernatant, the resin was washed with DMF (5×1 mL). Subsequently, 1.5 mL of 0.6 M 8-hydroxyquinoline (Nqn) in NMP, along with 100 mg of K₂CO₃, were added to the resin. The mixture was stirred overnight at room temperature, filtered, and washed with DMF (5×1 mL).

Syntheses of Pep-5, Pep-7, Pep-8 and Pep-9. Pep-5 [NH₂-(Nbrpe)₆(Nce)₆-Nqn₂]: 2829.97 (Molecular weight), 1416.54 (Found: [M/2+H]⁺), 944.09 (Found: [M/3+H]⁺); Pep-7 [NH₂-(Nbrpe)₆-Nqn₂]: 2055.28 (Molecular weight), 1028.74 (Found: [M/2+H]⁺); Pep-8 [NH₂-(Nbrpe)₆(Nce)₃-Nqn₂]: 2442.63 (Molecular weight), 1221.91 (Found: [M/2]⁺), 815.45 (Found: [M/3]⁺); Pep-9 [NH₂-(Nbrpe)₆(Nce)₉-Nqn₂]: 3217.62 (Molecular weight), 1610.66 (Found: [M/2+H]⁺), 1073.97 (Found: [M/3+H]⁺). Pep-5, Pep-7, Pep-8 and Pep-9 were synthesized through the functionalization of Pep-1 via the submonomer procedure. Typically, Pep-1 (0.09 mmol, 1 equiv.) was mixed with 1.5 mL of 0.6 M bromoacetic acid and 0.3 mL of 50/50 (v/v) DIC/DMF for 10 min before removing the supernatant and washing with DMF (5×1 mL). Subsequently, 1.5 mL of 0.6 M of tris(2-aminoethyl)amine in NMP was added to the above resin, and the mixture was stirred overnight at room temperature, filtered, and washed with DMF (5×1 mL). One more acylation cycle was performed using 3 mL of 0.6 M bromoacetic acid and 0.6 mL of 50/50 (v/v) DIC/DMF. Afterward, 3 mL of 0.6 M Nqn in NMP and 200 mg K₂CO₃ were added to the above resin, and the mixture was stirred overnight at room temperature, filtered, and washed with DMF (5×1 mL).

Synthesis of Pep-6. [NH₂-(Nbrpe)₆(Nce)₆-Do3a]: 2618.73 (Molecular weight), 1309.92 (Found: [M/2+H]⁺). Pep-6 was synthesized through the functionalization of Pep-1 using the submonomer procedure. Typically, Pep-1 (0.09 mmol, 1 equiv.) was mixed with 1.5 mL of 0.6 M bromoacetic acid and 0.3 mL of a 50/50 (v/v) DIC/DMF mixture for 10 minutes. After removing the supernatant, the resin was washed with DMF (5×1 mL). Subsequently, a mixture containing 1,4,7,10-tetraazacyclododecane-1,4,7-triacetic acid trisodium salt (Do3a) (231.3 mg, 0.45 mmol, 5 equiv.), K₂CO₃ (24.9 mg, 0.18 mmol, 2 equiv.), and tetra-N-butylammonium iodide (49.9 mg, 0.135 mmol, 1.5 equiv.) in 3 mL of DMF was added to the resin. The reaction mixture was stirred overnight at room temperature, filtered, and washed with DMF (5×1 mL).

Synthesis of Pep-10 [NH₂-(Nbrpe)₆(Nome)₆-Nqn₂]: 2746.77 (Molecular weight), 1374.69 (Found: [M/2+H]⁺), 916.64 (Found: [M/3+H]⁺). To synthesize the first 12 units of Pep-10, the protocol used for Pep-1 was repeated. However, in the later acylation steps, 2-methoxyethyl amine (Nome) was used instead of Nee. After the completion of these steps, the resulting intermediate was further functionalized with Nqn using a protocol similar to that of Pep-5.

Synthesis of Pep-11 [NH₂-(Nbrpe)₆(Nae)₆-Nqn₂]: 2656.01 (Molecular weight), 886.12 (Found: [M/3+H]⁺). To synthesize the first 12 units of Pep-11, the protocol used for Pep-1 was repeated. However, in the later acylation steps, tert-butyl (2-aminoethyl)carbamate (Nae) was used instead of beta-alanine tert-butyl ester. After completing these steps, the resulting intermediate was further functionalized with Nqn using a protocol similar to that of Pep-5.

Synthesis of Pep-12 and Pep-13. Pep-12 [NH₂-(Nbrpe)₆(Nome)₄(Nae)₂-Nqn₂]: 2716.05 (Molecular weight), 1359.95 (Found: [M/2+H]⁺), 906.45 (Found: [M/3+H]⁺); Pep-13 [NH₂-(Nbrpe)₆(Nae)₂(Nome)₄-Nqn₂]: 2716.05 (Molecular weight), 905.70 (Found: [M/3+H]⁺). To synthesize the first 12 units of Pep-12 and Pep-13, the protocol of Pep-1 was repeated. However, the Nome and Nae were used instead of beta-alanine tert-butyl ester in the later acylation steps. Then, it was further functionalized with Nqn by using a similar protocol of Pep-5.

Synthesis of Pep-14 [NH₂-(Nbrpe)₆(Nae)₆-Npm₂Nqn₂]: 2950.36 (Molecular weight), 984.85 (Found: [M/3+H]⁺). To synthesize the first 12 units of Pep-14, the synthetic protocol of Pep-1 was repeated. However, the Nae was used instead of Nee in the six later acylation steps. Then, it was mixed with 1.5 mL of 0.6 M bromoacetic acid and 0.3 mL of 50/50 (v/v) DIC/DMF for 10 min before removing the supernatant and washing with DMF (5×1 mL). Subsequently, 1.5 mL of 0.6 M of tris(2-aminoethyl)amine in NMP was added to the above resin, and the mixture was stirred overnight at room temperature, filtered, and washed with DMF (5×1 mL). Furthermore, an acylation cycle was performed using 1.5 mL of 0.6 M bromoacetic acid and 0.6 mL of 50/50 (v/v) DIC/DMF. Nucleophilic displacement of bromide with the submonomers occurred by adding 1.5 mL of 0.6 M benzylamine solution in NMP, followed by agitating for 10 min at room temperature. The solution was filtered off, and the resins were washed with DMF (5×1 mL). One more acylation cycle was performed using 3 mL of 0.6 M bromoacetic acid and 0.6 mL of 50/50 (v/v) DIC/DMF. Finally, 3 mL of 0.6 M Nqn in NMP and 200 mg K₂CO₃ were added to the above resin, and the mixture was stirred overnight at room temperature, filtered, and washed with DMF (5×1 mL).

Synthesis of Pep-15 [NH₂-(Nbrpe)₆(Nae)₆-Nip₂Nqn₂]: 2854.27 (Molecular weight), 1428.97 (Found: [M/2+H]⁺), 952.74 (Found: [M/3+H]⁺). To synthesize the first 12 units of Pep-15, the synthetic protocol of Pep-1 was repeated. However, the Nae was used instead of Nee in the six later acylation steps. Then, it was mixed with 1.5 mL of 0.6 M bromoacetic acid and 0.3 mL of 50/50 (v/v) DIC/DMF for 10 min before removing the supernatant and washing with DMF (5×1 mL). Subsequently, 1.5 mL of 0.6 M of tris(2-aminoethyl)amine in NMP was added to the above resin, and the mixture was stirred overnight at room temperature, filtered, and washed with DMF (5×1 mL). Furthermore, an acylation cycle was performed using 1.5 mL of 0.6 M bromoacetic acid and 0.6 mL of 50/50 (v/v) DIC/DMF. Nucleophilic displacement of bromide with the submonomers occurred by adding 1.5 mL of 0.6 M isopropyl amine solution in NMP, followed by agitating for 10 min at room temperature. The solution was filtered off, and the resins were washed with DMF (5×1 mL). One more acylation cycle was performed using 3 mL of 0.6 M bromoacetic acid and 0.6 mL of 50/50 (v/v) DIC/DMF. Finally, 3 mL of 0.6 M Nqn in NMP and 200 mg K₂CO₃ were added to the above resin, and the mixture was stirred overnight at room temperature, filtered, and washed with DMF (5×1 mL).

### Purification and Mass Spectrometry Analysis:

The cleavage of peptoids from the resins was carried out by treating the bead resins with 3 mL of 95/5 (v/v) trifluoroacetic acid (TFA)/H₂O for 30 minutes with agitation. The solution was collected and the TFA solution was evaporated under reduced pressure at 36° C. The crude peptoid product was dissolved in 80/20 (v/v) acetonitrile/H₂O and purified by reverse-phase high-performance liquid chromatography (HPLC, Water 1525) set up with an XBridge™ Prep C18 OBD™ column, 10 μm, 19 mm×100 mm, using a linear gradient of 45-55% (for Pep-2, Pep-5) or 50-70% (for the other peptoids) acetonitrile in water with 0.1% TFA. Mass spectrometry characterization of purified peptoids was conducted following known methods.

### Evaluation of Metal-Peptoid Binding:

The binding of metal and peptoid was examined via UV-vis titration in acetonitrile solvent. After collecting the blank spectrum of acetonitrile in the 250-700 nm range, 100 μL of peptoids (1 mM stock solution) was diluted in 900 μL of acetonitrile to attain a final concentration of 0.1 mM. Each peptoid was titrated separately to gain the absorbance spectrum of individual complexes by adding 1 μL of Co(BF₄)₂ solution. Extracting the change in absorbance at a specific wavelength provides the binding ratio between metal and peptoid.

### Quantitative Metal-Peptoid Binding Efficiency:

The amount of metal held on the peptoid membranes was systematically determined through the colorimetry titration procedure using Eriochrome Black T (EBT) as a titrant. To assemble the metal-peptoid membrane, water was added to reach a final volume of 600 μL, and then the solution was centrifuged at 8,000×g for 10 min. Subsequently, 400 μL of supernatant was collected, and fresh 400 μL of water was added to the peptoid solution again to perform 2nd washing cycle. This washing process was repeated until no metal bleaching was detected. To determine the metal residence in the collected supernatant, 10 μL of supernatant was added to 610 μL of EBT (70 mM, pH=10). The change in the absorbance of EBT was monitored by using a UV/vis spectrometer. A similar procedure was conducted with the fresh metal salt solutions to establish the calibration curve, as shown in FIGS. 9A-9F.

### Catalytic Activity Test of Metal-Peptoid Nanomembranes Toward DMNP Hydrolysis:

The catalytic activity was carried out in a Tecan Safire 2 microplate reader. Each well was prepared with 180 μL of a total volume containing: 153 μL buffer ([N-ethylmorpholine]=20 mM, pH=10), 22.5 μL of catalyst (1 mM of peptoid powder, metal salts or self-assembled peptoid premixed in water and sonicated before using) and 4.5 μL of DMNP ([DMNP=10 mM in methanol). Upon adding the substrate, the 96-well plate was immediately put into the reader to monitor the change in absorbance at 400 nm. The conversion was calculated based on an established calibration curve with various given amounts of 4-nitrophenol in NEM buffer (FIG. 13B). Reported activity is the average value for three replicates with background subtraction.

### A General Protocol for Recycle Peptoid Membranes:

After each catalytic cycle, the reaction mixture was transferred into a 1.5 mL Eppendorftube. The peptoids were then collected by centrifuging at 10,000×g for 10 minutes. Subsequently, the supernatant was gently removed using a pipette, and the membrane was resuspended in fresh water. This process of centrifugation, pelleting the membrane, and resuspension in water was repeated twice. Prior to hydrolysis, the recovered peptoid membranes were resuspended in NEM buffer for a minimum of 2 hours.

### Characterization:

Atomic force microscopy (AFM) characterization: Ex situ AFM analysis was carried out on a Brucker MultiMode 8 by using ScanAsyst mode at room temperature. For sample preparation, 1.5 μL of the self-assembled peptoid was diluted 40× with deionized water and deposited onto a mica substrate. After 5 min, Whatman filter paper was applied to remove the solution, and then the dried mica substrate was further dried under N₂ flow). The AFM probe consisted of silicon tips on silicon cantilevers (NCHV probes, k=42 Nim, tip radius).

Transmission electron microscopy (TEM): TEM images were taken from the samples on a 3-mm diameter copper grid coated with carbon film using the FEI Tecnai G2 transmission electron microscope with an accelerating voltage of 200 kV and ETEM (FEI) operated at 200 kV.

X-ray diffraction (XRD) analysis: All characterization was carried out following known procedures. Typically, powder XRD data were gathered on a multiple wavelength anomalous diffraction and monochromatic macromolecular crystallography beamline, 8.3.1 (possessing a 5 T single pole superbend source with an energy range of 5-17 keV) at the Advanced Light Source located at Lawrence Berkeley National Laboratory. All XRD data were collected with a 3×3 CCD array (ADSC Q315r) detector at a wavelength of 1.11583 Å. Datasets were collected with the detector 200 mm from the sample. For XRD sample preparations, samples of peptoid assemblies were loaded onto a Kapton mesh (MiTeGen) and dried for XRD measurements. All XRD Data were analyzed using custom Python scripts.

Fluorescence analysis of assembled nanomembranes: The peptoid assemblies were labeled with Nile red dye using well-established protocols. The labeled membranes were then visualized using the Zeiss LSM 710 confocal microscope system, which is equipped with a Zeiss AXIO Observer Zl inverted microscope stand. The microscope system utilizes transmitted (HAL), UV (HBO), and laser illumination sources. For imaging, the samples were excited at 561 nm and images were collected at a magnification of 20× and 40×.

X-ray photoelectron spectroscopy (XPS) analysis: XPS analysis was performed using a Kratos Axis Ultra DLD spectrometer, which consists of an Al Ka monochromatic X-ray source (1486.6 eV) and a high-resolution spherical mirror analyzer. X-ray source was operated at 150 W power and the emitted photoelectrons were collected at the analyzer entrance slit normal to the sample surface. The high-resolution spectra were collected at a pass energy of 40 eV with a step sized of 0.1 eV. The Kratos charge neutralizer system was used for all analyses with charge neutralization being monitored using the C is signal. XPS data were analyzed using CasaXPS software. All the XPS peaks were charge referenced to C 1s signal (C—C/C—H) at 285 eV.

Many variations will suggest themselves to those skilled in the art in light of the above detailed description. All such obvious variations are within the full intended scope of the appended claims. Other aspects of the disclosure can include, but are not limited to, the following (aspects are described as “comprising” but, alternatively, can “consist essentially of” or “consist of” unless specifically stated otherwise):

Aspect 1. A membrane comprising a plurality of peptoids, at least one peptoid of the plurality of peptoids comprise:
a hydrophobic unit;
a hydrophilic unit; and
a metal-coordination ligand.

Aspect 2. The membrane of aspect 1, wherein the membrane comprises a bilayer such that the hydrophilic units of the plurality of peptoids are positioned on a surface of the membrane.

Aspect 3. The membrane of aspects 1 or 2, wherein the metal-coordination ligand is positioned near a surface of the membrane.

Aspect 4. The membrane of any of aspects 1-3, further comprising one or more metal ions.

Aspect 5. The membrane of any of aspects 1-4, wherein the metal ions bind with the metal-coordination ligand.

Aspect 6. The membrane of any of aspects 1-4, wherein the metal ion is a transition metal selected from titanium, vanadium, chromium, manganese, iron, cobalt, nickel, copper, zinc, lanthanum, europium, zirconium, silver, gold, or combinations thereof.

Aspect 7. The membrane of any of aspects 1-4, wherein the metal ions are positioned near a surface of the membrane.

Aspect 8. The membrane of any of aspects 1-7, wherein the membrane comprises a ratio of peptoid to metal ion of about 1:1.

Aspect 9. The membrane of any of aspects 1-7, wherein the membrane comprises a ratio of peptoid to metal ion of about 1:2.

Aspect 10. The membrane of any of aspects 1-9, wherein the hydrophilic unit comprises an amino group, a hydroxyl group, a carboxyl group, a methoxy group, or combinations thereof.

Aspect 11. The membrane of any of aspects 1-10, wherein the metal-coordination ligand comprises at least one of pyridyl, 8-hydroxyguinoline, N-(2-amino-2-oxoethyl)-N-(pyridin-4-ylmethyl)-2-((pyridin-4-ylmethyl)amino)acetamide (“Npy2”), 1-(2-(N-(2-amino-2-oxoethyl)-2-(quinolin-8-yloxy)acetamido)ethyl)-3-oxo-1-(2-(2-(quinolin-8-yloxy)acetamido)ethyl)piperazin-1-ium (“Nqn2”), N-(2-methoxyethyl)glycine (“Nome”), N-(2-aminoethyl)glycine) (“Nae”), N-(1-phenylmethyl)glycine (“Npm”), N-(isopropyl)glycine (“Nip”), 1,4,7,10-tetraazacyclododecane-N,N,N,N-tetraacetic acid (“DOTA”), 1,4,7-triazacyclononane-N,N,N-triacetic acid (“NOTA”), 1,4,8,11-tetraazacyclotetradecane-1,4,8,11-tetraacetic acid (“TETA”), diethylenetriaminepentaacetic acid (“DTPA”), iminodiacetic acid (“IDA”), 4,11-bis(carboxymethyl)-1,4,8,11-tetraazabicyclo[6.6.2]hexadecane (“CB-TE2A”), 1,8-Diamino-3,6,10,13,16,19-hexaazabicyclo[6,6,6]-eicosane (“DiAmSar”), and 3,3′,3″-(((1,4,7-triazonane-1,4,7-triyl)tris(methylene))tris(hydroxyphosphoryl))tripropanoic acid (“TRAP”), or combinations thereof.

Aspect 12. The membrane of any of aspects 1-11, wherein the membrane is crystalline.

Aspect 13. The membrane of any of aspects 1-12, wherein a peptoid among the plurality of peptoids comprises the following formula (I):

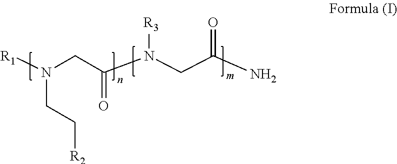

wherein:
R₁ is the metal-coordination ligand;
R₂ is hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
n is 1 to 10;
m is 1 to 10; and wherein any of the aforementioned can be substituted or unsubstituted.

Aspect 14. The membrane of any of aspects 1-12, wherein a peptoid among the plurality of peptoids comprises the following formula (II):

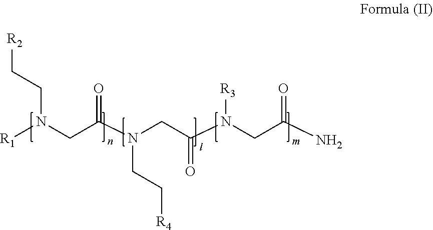

wherein:
R₁ is the metal-coordination ligand;
R₂ and R₄ are each independently selected from hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
l is 0 to 10;
n is 1 to 10;
m is 1 to 10; and
wherein any of the aforementioned can be substituted or unsubstituted.

Aspect 15. The membrane of aspect 13 or 14, wherein:

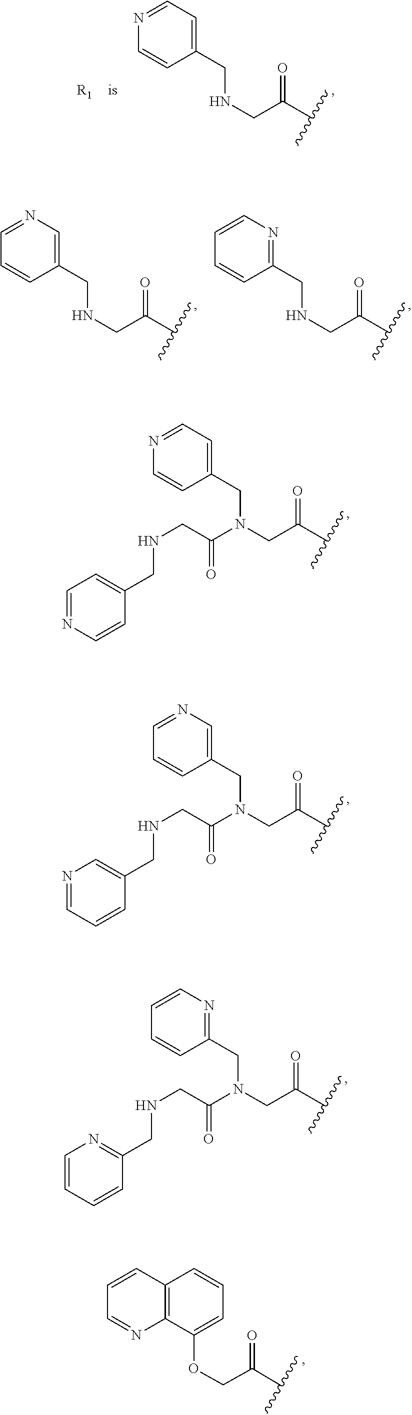

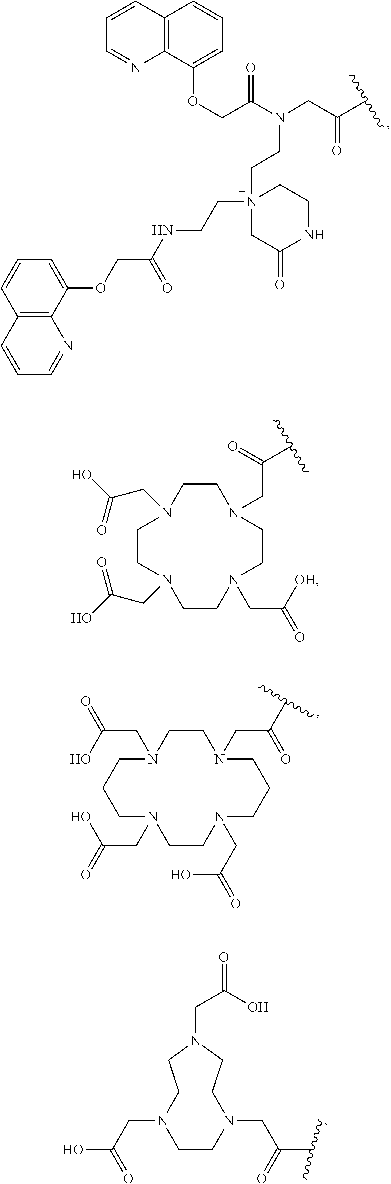

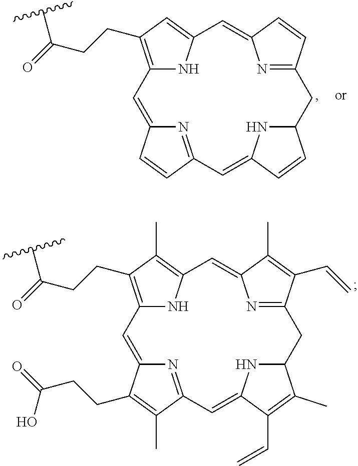

R₂ and R₄ are each independently selected from —COOH, —OCH₃, and —NH₂;
R₃ is

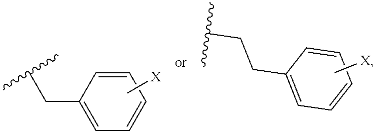

where X is a halogen;
n is 2, 3, 4, 5, or 6; and
m is 2, 3, 4, 5, or 6.

### Br

Aspect 16. The membrane of aspect 15, wherein R₃ is

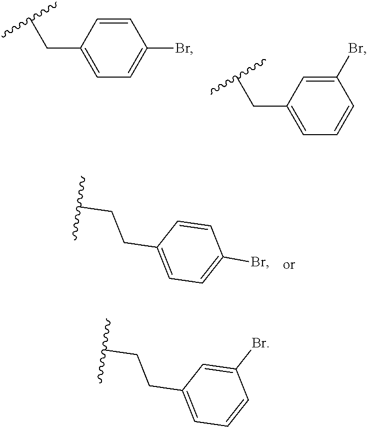 [SMILES: *Cc1ccc(Br)cc1 ; *Cc1cccc(Br)c1 ; *CCc1ccc(Br)cc1 ; *CCc1cccc(Br)c1]

Aspect 17. The membrane of any of aspects 1-16, wherein the membrane is configured to hydrolyze an ester group or a phosphate ester group in a compound.

Aspect 18. The membrane of any of aspects 1-16, wherein the membrane is configured to oxidize a thiol group, a sulfide group, a sulfhydryl group, or combinations thereof, in a compound.

Aspect 19. The membrane of any of aspects 1-18, wherein the membrane is configured to self-assemble.

Aspect 20. An article comprising a solid substrate and the membrane of aspects 1-19.

Aspect 21. The article of aspect 20, wherein the solid substrate comprises a piece of clothing, fabric, string, matrix, collagen, leather, paper, polymer, plastic, glass, wood, metal surface, cement, soil, rock, or solid aggregate of minerals or mineraloids.

Aspect 22. A method for hydrolyzing a compound comprising a phosphate ester group, the method comprising exposing the membrane of aspects 1-19 to a compound comprising an ester group or a phosphate ester group such that the compound is hydrolyzed.

Aspect 23. A method for hydrolyzing a compound comprising a phosphate ester group, the method comprising exposing the article of aspect 20 or 21 to a compound comprising an ester group or a phosphate ester group such that the compound is hydrolyzed.

Aspect 24. The method of aspect 22 or 23, wherein the compound comprising a phosphate ester group comprises a pesticide.

Aspect 25. A peptoid membrane for degrading organophosphates, the peptoid membrane comprising a plurality of peptoids comprising one or more metal-coordination ligands configured to bind with one or more metal ions.

Aspect 26. The peptoid membrane of aspect 25, wherein the peptoid membrane comprises a bilayer, wherein the one or more metal-coordination ligands are positioned near a surface of the bilayer.

Aspect 27. The peptoid membrane of aspect 25 or 26, wherein the peptoid membrane comprises a peptoid having the following formula (I):

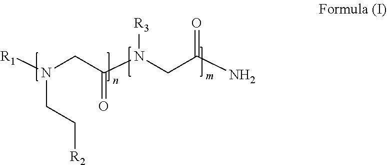

wherein:
R₁ is the metal-coordination ligand;
R₂ is hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
n is 1 to 10;
m is 1 to 10; and
wherein any of the aforementioned can be substituted or unsubstituted.

Aspect 28. The peptoid membrane of aspect 25 or 26, wherein the peptoid membrane comprises a peptoid having the following formula (II):

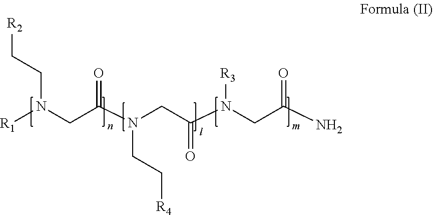

wherein:
R₁ is the metal-coordination ligand;
R₂ and R₄ are each independently selected from hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
l is 0 to 10;
n is 1 to 10;
m is 1 to 10; and
wherein any of the aforementioned can be substituted or unsubstituted.

Aspect 29. The peptoid membrane of aspect 27 or 28, wherein:

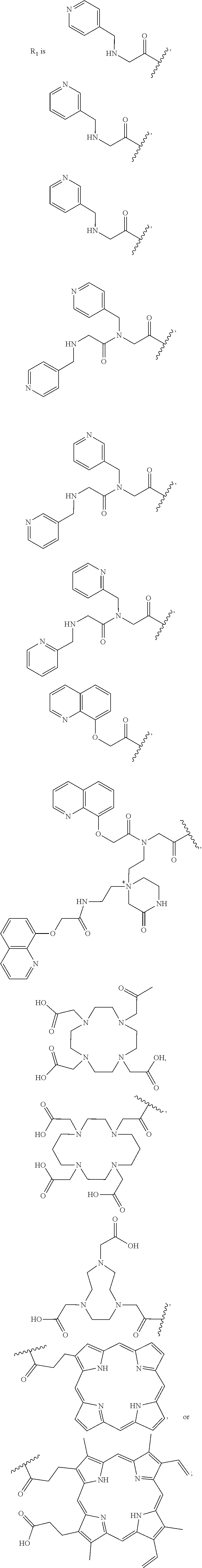

R₂ and R₄ are each independently selected from −000H, —OCH₃, and —NH₂;
R₃ is

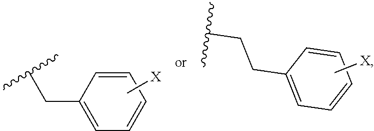

where X is a halogen;
l is 2, 3, 4, 5, or 5;
n is 2, 3, 4, 5, or 6; and
m is 2, 3, 4, 5, or 6.

Aspect 30. The peptoid membrane of aspect 29, wherein R₃ is

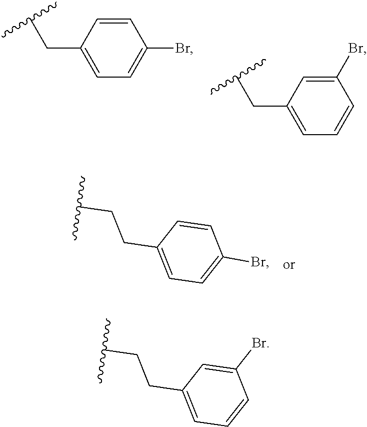 [SMILES: *Cc1ccc(Br)cc1 ; *Cc1cccc(Br)c1 ; *CCc1ccc(Br)cc1 ; *CCc1cccc(Br)c1]

Aspect 31. The peptoid membrane of any of aspects 25-30, wherein the metal ion is a transition metal selected from titanium, vanadium, chromium, manganese, iron, cobalt, nickel, copper, zinc, lanthanum, europium, zirconium, silver, gold, or combinations thereof.

Aspect 32. The peptoid membrane of any of aspects 25-31, wherein the peptoid membrane comprises a ratio of peptoid to metal ion of about 1:1.

Aspect 33. The peptoid membrane of any of aspects 25-31, wherein the peptoid membrane comprises a ratio of peptoid to metal ion of about 1:2.

Aspect 34. The peptoid membrane of any of aspects 25-33, wherein the peptoid membrane is configured to hydrolyze an ester group or a phosphate ester group in a compound.

Aspect 35. The peptoid membrane of any of aspects 25-33, wherein the peptoid membrane is configured to oxidize a thiol group, a sulfide group, a sulfhydryl group, or combinations thereof, in a compound.

Aspect 36. A method for degrading a pesticide, the method comprising:
combining a peptoid membrane with one or more metal ions, wherein a peptoid among the plurality of peptoids comprises the following formula (II):

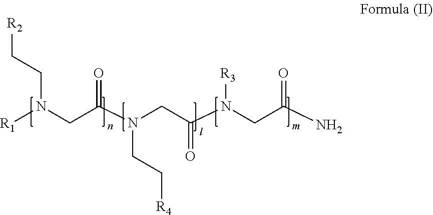

wherein:
R₁ is the metal-coordination ligand;
R₂ and R₄ are each independently selected from hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
l is 0 to 10;
n is 1 to 10;
m is 1 to 10; and
wherein any of the aforementioned can be substituted or unsubstituted;
crystallizing the peptoid membrane; and
exposing the peptoid membrane to a pesticide such that at least a portion of the pesticide is hydrolyzed.

Aspect 37. The method of aspect 36, further comprising embedding a solid substrate with the peptoid membrane and one or more metal ions.

Aspect 38. The method of aspect 36 or 37, wherein the solid substrate comprises a piece of clothing, fabric, string, matrix, collagen, leather, paper, polymer, plastic, glass, wood, metal surface, cement, soil, rock, or solid aggregate of minerals or mineraloids.

Aspect 39. The method of any of aspects 36-38, wherein the metal ion is a transition metal selected from titanium, vanadium, chromium, manganese, iron, cobalt, nickel, copper, zinc, lanthanum, europium, zirconium, silver, gold, or combinations thereof.

Aspect 40. The method of any of aspects 36-39, wherein the peptoid membrane comprises a ratio of peptoid to metal ion of about 1:1.

Aspect 41. The method of any of aspects 36-39, wherein the peptoid membrane comprises a ratio of peptoid to metal ion of about 1:2.

Aspect 42. The method of any of aspects 36-41, wherein R₁ is

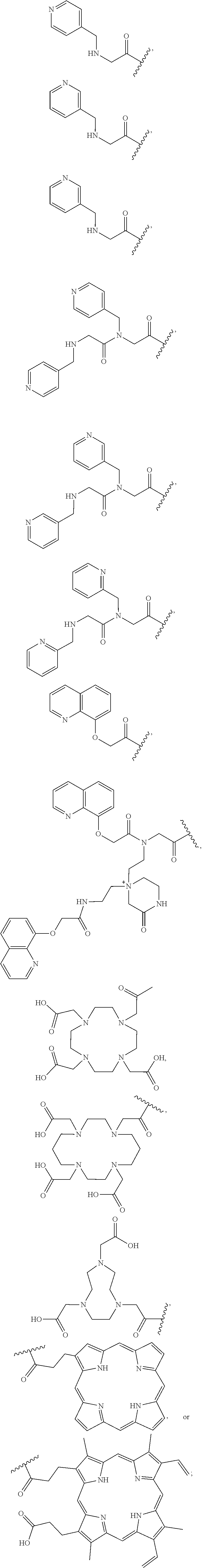

R₂ and R₄ are each independently selected from —COOH, —OCH₃, and —NH₂;

R₃ is

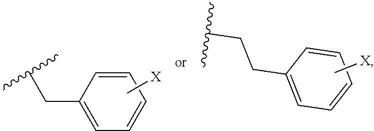

where X is a halogen;
l is 2, 3, 4, 5, or 5;
n is 2, 3, 4, 5, or 6; and
m is 2, 3, 4, 5, or 6.

Aspect 43. The method of aspect 42, wherein R₃ is

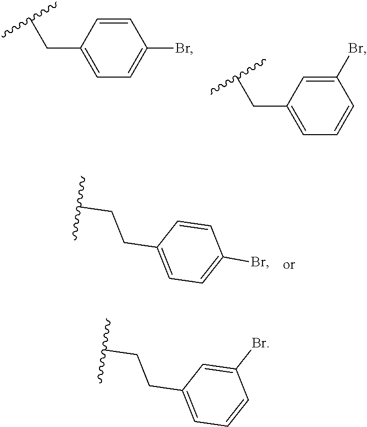 [SMILES: *Cc1ccc(Br)cc1 ; *Cc1cccc(Br)c1 ; *CCc1ccc(Br)cc1 ; *CCc1cccc(Br)c1]

1. A membrane comprising a plurality of peptoids, at least one peptoid of the plurality of peptoids comprise:
a hydrophobic unit;
a hydrophilic unit; and
a metal-coordination ligand.

2. The membrane of claim 1, wherein a peptoid among the plurality of peptoids comprises the following formula (I): 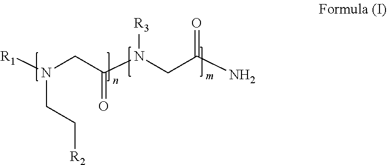
wherein:
R₁ is the metal-coordination ligand;
R₂ is hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
n is 1 to 10;
m is 1 to 10; and
wherein any of the aforementioned can be substituted or unsubstituted.

3. The membrane of claim 1, wherein a peptoid among the plurality of peptoids comprises the following formula (II): 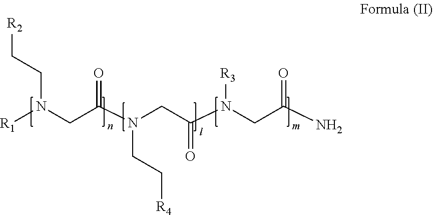
wherein:
R₁ is the metal-coordination ligand;
R₂ and R₄ are each independently selected from hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
l is 0 to 10;
n is 1 to 10;
m is 1 to 10; and
wherein any of the aforementioned can be substituted or unsubstituted.

4. The membrane of claim 2, wherein: 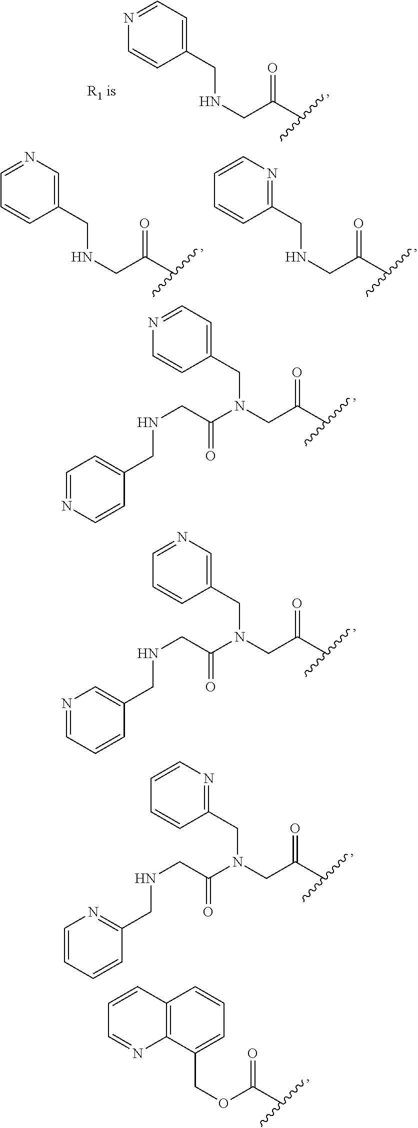 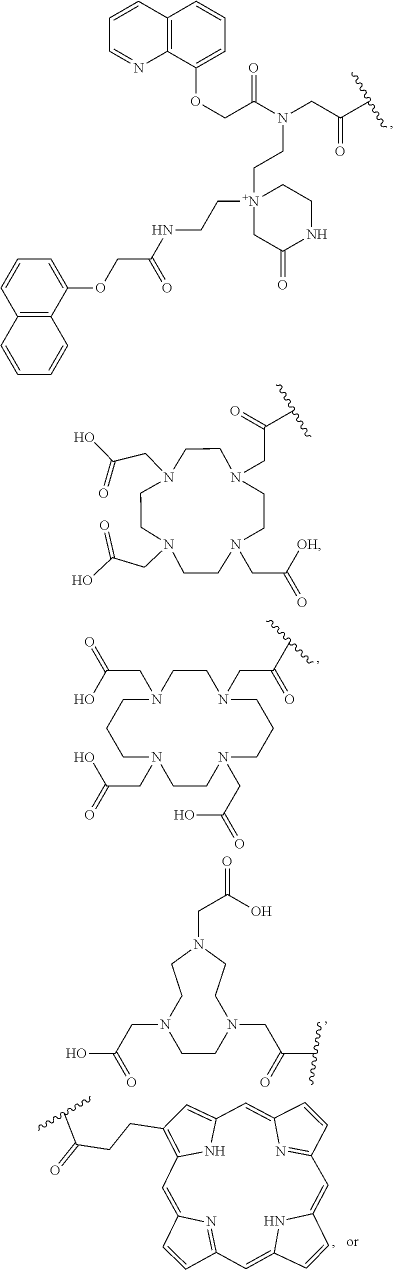 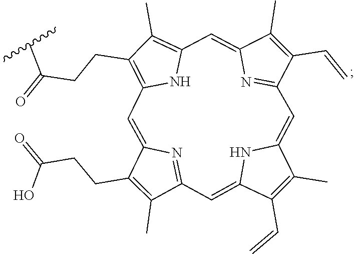 [SMILES: *C(=O)CCc1c(C)c2cc3nc(cc4[nH]c(cc5nc(cc1[nH]2)C(CCC(=O)O)=C5C)c(C=C)c4C)C(C=C)=C3C]
R₂ and R₄ are each independently selected from —COOH, —OCH₃, and —NH₂;
R₃ is 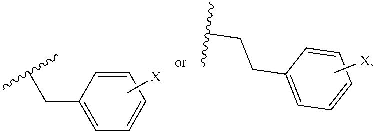
or X is a halogen;
n is 2, 3, 4, 5, or 6; and
m is 2, 3, 4, 5, or 6.

5. The membrane of claim 1, wherein the membrane is crystalline.

6. The membrane of claim 1, further comprising one or more metal ions.

7. The membrane of claim 6, wherein the metal ions bind with the metal-coordination ligand.

8. The membrane of claim 6, wherein the metal ion is a transition metal selected from titanium, vanadium, chromium, manganese, iron, cobalt, nickel, copper, zinc, lanthanum, europium, zirconium, silver, gold, or combinations thereof.

9. The membrane of claim 6, wherein the membrane comprises a ratio of peptoid to metal ion of about 1:1.

10. The membrane of claim 1, wherein the membrane is configured to hydrolyze an ester group or a phosphate ester group in a compound.

11. The membrane of claim 1, wherein the membrane is configured to oxidize a thiol group, a sulfide group, a sulfhydryl group, or combinations thereof, in a compound.

12. An article comprising a solid substrate and the membrane of claim 1.

13. The article of claim 12, wherein the solid substrate comprises a piece of clothing, fabric, string, matrix, collagen, leather, paper, polymer, plastic, glass, wood, metal surface, cement, soil, rock, or solid aggregate of minerals or mineraloids.

14. A method for hydrolyzing a compound comprising a phosphate ester group, the method comprising exposing the membrane of claim 1 to a compound comprising an ester group or a phosphate ester group such that the compound is hydrolyzed.

15. A peptoid membrane for degrading organophosphates, the peptoid membrane comprising a plurality of peptoids comprising one or more metal-coordination ligands configured to bind one or more metal ions.

16. The membrane of claim 15, wherein the peptoid membrane comprises a peptoid having the following formula (II): 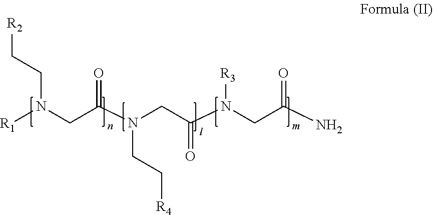
wherein:
R₁ is the metal-coordination ligand;
R₂ and R₄ are each independently selected from hydrogen, —OH, —COOH, —OCH₃, —NH₂, —SH, and —PO₃;
R₃ is hydrogen, alkyl, alkenyl, alkynyl, benzyl, phenyl, alkyl phenyl, cycloalkyl, cycloalkenyl, aryl, heteroalkyl, heteroalkenyl, heteroalkynyl, heterocycloalkyl, heterocycloalkenyl, and heteroaryl;
l is0 to 10;
n is 1 to 10;
m is 1 to 10; and
wherein any of the aforementioned can be substituted or unsubstituted.

17. The membrane of claim 16, wherein: 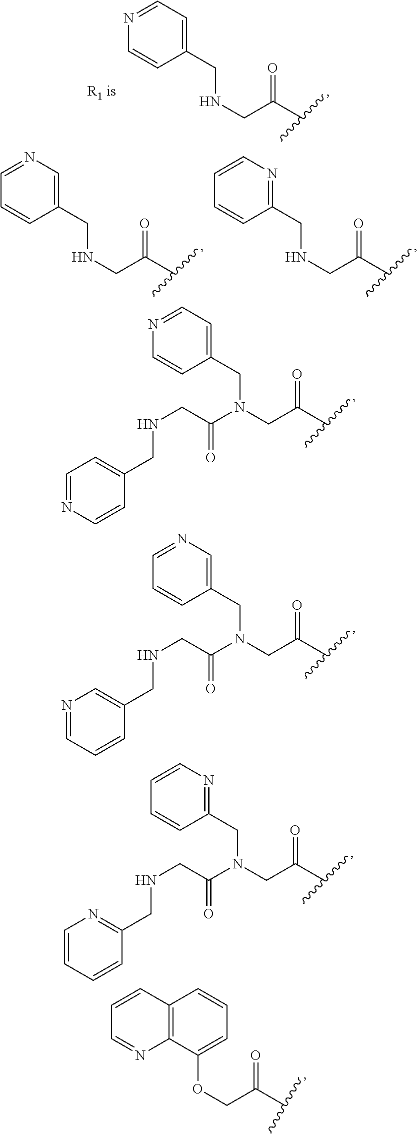 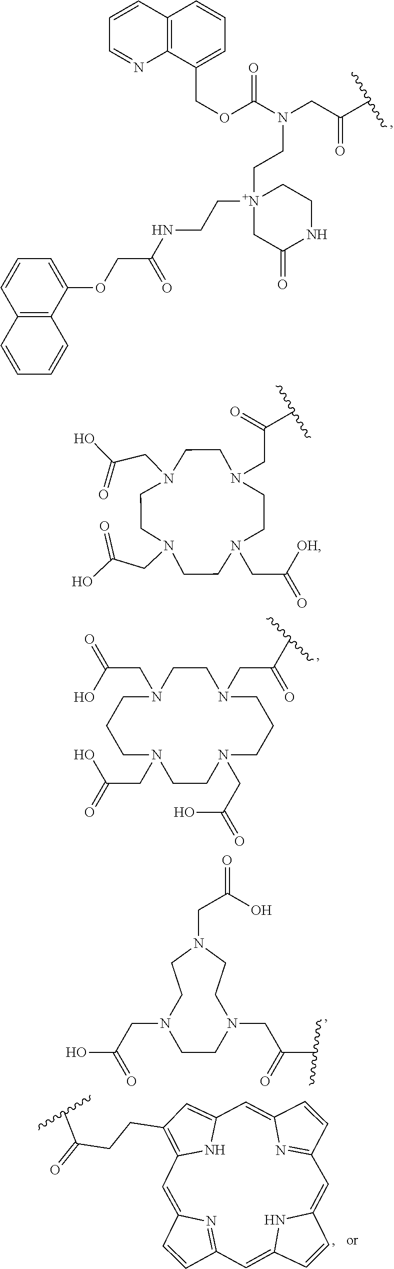 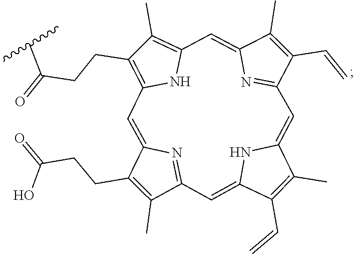 [SMILES: *C(=O)CCc1c(C)c2cc3nc(cc4[nH]c(cc5nc(cc1[nH]2)C(CCC(=O)O)=C5C)c(C=C)c4C)C(C=C)=C3C]
R₂ and R₄ are each independently selected from —COOH, —OCH₃, and —NH₂;
R₃ is 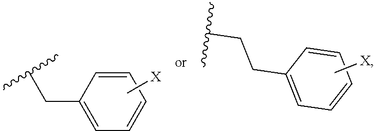
where X is a halogen;
l is 2, 3, 4, 5, or 5;
n is 2, 3, 4, 5, or 6; and
m is 2, 3, 4, 5, or 6.

18. The membrane of claim 15, wherein the metal ion is a transition metal selected from titanium, vanadium, chromium, manganese, iron, cobalt, nickel, copper, zinc, lanthanum, europium, zirconium, silver, gold, or combinations thereof.

19. The membrane of claim 15, wherein the membrane is configured to hydrolyze an ester group or a phosphate ester group in a compound.

20. The membrane of claim 15, wherein the membrane is configured to oxidize a thiol group, a sulfide group, a sulfhydryl group, or combinations thereof, in a compound.
